(19) United States
(12) Patent Application Publication
(10) Pub. No.: US 2009/0038864 A1
(43) Pub. Date: Feb. 12, 2009

(54) REMOTELY CONTROLLABLE GOLF CART AND METHOD FOR STEERING A CART

(76) Inventor: Sung Yol Yun, Henderson, NV (US)

Correspondence Address: AARON L. PATTON, 4401 ATLANTIC AVENUE, SUITE 200, LONG BEACH, CA, 90807, US

(21) Appl. No.: 12/187,347

(22) Filed: Aug. 6, 2008

Related U.S. Application Data
(60) Provisional application No. 60/963,986, filed on Aug. 7, 2007.

(51) Int. Cl. B62D 51/04

(52) U.S. Cl. 180/19.1

(57) ABSTRACT

The invention relates to a cart for carrying one or more a golf bags and/or other things, which cart is moveable on wheels and operable in response to transmission of one or more command signals generated in response to activation of at least one operator input device, preferably mounted on or in a remote control, and a method for steering a cart. In one aspect, the cart includes a front-located drive wheel assembly with a drive motor for moving the cart forward by driving at least one drive wheel, and at least one rear-located steerable wheel assembly for turning the cart while it is moving forward. The steerable wheel assembly comprises a steering motor, a center-lock device, and a cart steering wheel. The steering motor and center-lock device may be electrically coupled to one another for coordinating their respective activations in response to one or more of the command signals for holding the steering wheel against pivoting, releasing the hold, and pivoting the cart steering wheel. And, the method includes steps that can be carried out by operation of such a cart.

### CROSS-REFERENCE TO RELATED APPLICATIONS

This application claims the benefit of U.S. Provisional Application No. 60/963,986 filed on Aug. 7, 2007.

### BACKGROUND OF THE INVENTION

The present invention relates to an apparatus for carrying a golf bag, particularly such an apparatus that is movable on wheels and is operable by remote control, and to a method for steering such a cart.

It is desirable for a golfer to have an apparatus that can carry his or her golf bag on wheels over the terrain of a golf course so that the bag and its contents are conveniently available for use by the golfer throughout his or her movement about the course. For many years golf bags were carried by the golfer or his caddy, and were typically equipped with a shoulder strap for that purpose. Then, golf bag carts (also referred to as a golf bag carriers, golf carts, or, simply, carts) were developed for carrying the bag on an apparatus that included a frame for holding the bag in place. The frames typically have two wheels connected to it for easing the movement of the cart, and typically also have a handle enabling the operator of the cart to push or pull as well as steer the cart. (See, for example, U.S. Pat. No. 3,191,957 issued to Meiklejohn on Jun. 29, 1965.)

Later, a cart drive motor was added. These carts typically have a frame shaped (while in their operational configuration which, for those carts that are foldable, is their unfolded configuration) substantially like a tricycle with two wheels at one end that are spaced apart presumably enough for the cart to be laterally stable during normal use. These two spaced-apart wheels are deemed to be the rear wheels based upon the directional convention that appears most commonly used. And, generally, another wheel (or pair of wheels that are very close to one another) is located at or near the other (narrow) end of the tricycle shape. Thus, this other wheel (or pair of wheels) are deemed to be the front wheel(s) based upon the same directional convention. (The motor on some carts appears intended only to assist an operator pull or push the cart rather than to move the cart on its own, so those carts sometimes provide only a foot—rest—support in place of a front wheel.) Generally speaking, each of the rear wheels and the front wheel(s) (or, front foot) is connected to a leg, with the legs typically coming together to form the apex of a tripod at some intermediate distance up the front leg. And, typically the front leg serves as a golf bag support leg and is usually inclined (sloped) away from the vertical—placing the bottom portion of the front leg forward of its top portion. In such carts, the front leg typically is equipped with golf bag holders (such as cradle-and-strap assemblies) for securing the bag to the front leg. Each of the rear legs generally extends downward (and usually outward and rearward) from the apex, to complete the tripod. Frequently, a separate handle arm is foldably connected to the upper end of the front leg. This arm, if unfolded, effectively extends the length of the front leg in an upward and rearward direction to end in a handle. Also, generally, drive wheels are rear wheels and non-drive wheels are front wheels. But, there also have been disclosures that instead designate one or two front wheel(s) as the drive wheel(s).

These powered carts usually have the drive motor operably coupled (for example via one or more gears—generally in a gearbox—and/or a drive chain/belt) to at least one drive wheel (a wheel powered by the drive motor for moving the cart forward and/or backward). (Sometimes a cart that has two drive wheels operates with each drive wheel powered independently of the other, by its own dedicated drive motor.) The power source for the cart, thus for its drive motor, is typically an electric battery such as a 12 volt battery (although sometimes use is made of a battery having more voltage, such as 24-36 volts). The cart battery is carried in a battery holder typically located, at least in part, within the area defined by the locations of the wheels and/or slightly behind the drive-wheel axle centerline.

And, these powered carts typically provide for the cart battery to be electrically connected to the drive motor(s) through circuitry that is conventionally employed to enable delivery of an appropriate level of electric power (combination of volts and current) from the cart battery to the drive motor(s) for the motor(s) to operate within design specifications. And, they typically provide a means for a cart operator to control the on/off switching (i.e., energizing/de-energizing) or the varying of such electric power to the drive motor(s). For example, they generally provide the operator with the ability to exercise such control by activating at least one operator input device, which typically is located on the cart's handle. It appears the operator input devices are normally connected to the cart battery (or to a separate, usually smaller-voltage, battery) through circuitry that is conventionally employed to enable delivery of an appropriate level of electric power from the cart battery (or smaller battery) to the operator input device, for it to operate within design specifications. The operator input device is typically in electrical communication with an electrical control device (such as a relay, potentiometer, rheostat, electric motor power and/or speed regulator, electric motor drive, or electric motor controller) that, in response to an electrical communication (wired or wireless signal) from the operator input device, effects the response “commanded” by the operator's activation of the operator input device (e.g., the operator's direction to close/open the circuit between the cart battery and the drive motor to turn the motor on/off, or vary the level of electric power delivered over that circuit to vary the motor's speed). Such conventional circuitry appears to be very well understood and in common use today, as is indicated by numerous commercially available carts advertised as having their drive wheel(s) driven by a battery powered electric motor that is manually controllable through manipulation of an operator input device for on-off and/or speed-control commands. These operator input devices are typically in the form of one or more pushbutton, toggle, and/or rocker switches and/or a dial-type potentiometer or rheostat mounted on or in the vicinity of the cart's handle. Examples of such manually controllable battery powered carts are: the “Explorer” from Bag Boy Co. of Richmond, Va.; the “Compact Plus” and the “Hi-Lite” from Hill Billy Powered Golf Trolley Ltd. of Sittingbourne, Kent, England; the “TS-1” from Lectronic Kaddy Corp. of Ontario, Canada; and, the “PowaKaddy” from PowaKaddy International Ltd. of Sittingbourne, Kent, England. (Also, see the following examples of patent document disclosures of battery powered carts: U.S. Pat. No. 4,289,324 issued to Nemeth on Sep. 15, 1981; U.S. Pat. No. 4,657,100 issued to Lewis on Apr. 14, 1987; U.S. Pat. No. 5,161,635 issued to Kiffe on Nov. 10, 1992; U.S. Pat. No. 5,526,894 issued to Wang on Jun. 18, 1996; U.S. Pat. No. 6,276,470 issued to Andreae, Jr., et al. on Aug. 21, 2002; U.S. Pat. No. 6,481,518 issued to Wu on Nov. 19, 2002 (front drive wheel with drive motor and gearbox held by wheel holder fastened to front end of cart's front leg); design U.S. Pat. No. 280,943 issued to Catford on Oct. 8, 1985; and U.K. patent application publication numbers GB2,215,291 by Catford published on Sep. 20, 1989; GB2,269,792 by Catford published on Feb. 23, 1994 (rear drive wheels on coaxial shafts turned by a central gearbox with worm gearing); and, GB2,322,686 by Catford published on Sep. 2, 1998.)

Other ideas have been presented wherein the cart is controllable by a separate remote transmitting device (also referred to as a transmitter, remote transmitter, remote control box, remote controller, or, simply, remote control), with at least one operator-input device (also discussed above) located onboard the remote control and capable, when activated, of causing the remote control to generate a wireless command signal (a wireless signal with a signature, such as one having predetermined characteristics—which characteristics may take many different forms including such forms as transmission frequencies, amplitudes, pulses, sequences, patterns or any combination thereof) to represent a command to turn a drive motor or steering motor (or wheel pivoting solenoid) on or off or to change the cart's speed. (Sometimes, remotely controllable carts have some or all of the same operator input devices on both the remote control and the handle, to retain the option of manual operation of the cart.)

Remotely controllable carts are described as also having an on-board wireless signal receiver (usually referred to simply as receiver) with a sensor that is compatible with the type of wireless signal the remote control transmits. The remote control and receiver combinations used for carts have been described, for example, as ones that transmit and receive in the radio or infrared frequency ranges, so the receiver in those combinations typically include a sensor such as a radio antenna or infrared sensor. Of course the receivers used would be ones that are compatible with the remote control so that they are capable of sensing the particular wireless command signal transmitted and responding by generating an appropriate electrical control signal for transmission (by wire or wirelessly) to an electrical control device (also discussed above). In response to receiving the electrical control signal, the electrical control device on those carts effects the command represented by that electrical control signal—e.g., by opening, closing, or modifying the power transmitted by an electrical circuit that connects the cart battery to a drive motor or a steering motor (or wheel pivoting solenoid).

Steering motors have been described as a single steering motor that pivots a non-drive wheel, and as a pair of independently activated drive motors each of which can serve as a steering motor by being selectively de-energized—e.g., allowing the cart to be turned by the wheel connected to the other (still energized) drive motor. And, a pair of horizontally disposed wheel pivoting solenoids have been employed for steering a rear-located non-drive wheel (or pair of wheels) of a cart having two widely spaced apart electric powered front drive wheels (in effect, the frame is a reversed tricycle frame—referred to here as reversed since it designates the two widely spaced apart wheels as being the front wheels rather than the rear wheels). Such steering is said to be accomplished by having each solenoid connected at one end to the cart frame and at the other end, via an axially extended arm, to a side of the non-drive wheel, and selectively energizing one or the other wheel pivoting solenoid (to retract its arm on that side) and thereby pivot the front wheel. (It is also noted that a motor may be substituted for each of the wheel pivoting solenoids—or a single two-directional motor for both of the wheel pivoting solenoids.)

Typically, the remote control includes separate operator-input devices for operating the drive motor and for steering the cart. Thus, the operator can activate one operator-input device to cause the remote control to transmit a wireless command signal that is a drive signal or activate another operator-input device to cause the remote control to transmit a wireless command signal that is a steering signal. A steering signal is similar to a drive signal, but represents a command for the receiver to respond by sending an electrical control signal to an electrical control device for a steering motor (or wheel pivoting solenoid) to steer the cart right or left, rather than to an electrical control device for a drive motor to move the cart forward or backward. (The electrical control device for a steering motor and the electrical control device for a drive motor may be a single electrical control device, if the device is able to discriminate between steering signals and drive signals and direct them properly. An example of this being, where steering is achieved by directing a drive signal to only one drive wheel when steering is desired but to both drive wheels when straight-ahead movement is desired.) An electrical control device for a steering motor (or wheel pivoting solenoid) can be as simple as a relay for opening or closing an electric circuit that provides the cart's battery power to the steering motor (or wheel pivoting solenoid).

The circuitry for operation of a remote control and an associated receiver and the communication of commanded signals to electrical control devices on the cart to control at least one drive motor and at least one steering motor (or wheel pivoting solenoid), is well understood and in common use today. The widespread application of such circuitry for this purpose is indicated by numerous commercially available electric carts being offered and used as remotely controllable golf bag carts. Examples of such remotely controllable electric carts are: the “Navigator” from Bag Boy Co. of Richmond, Va.; the “Dyna Steer” from Lectronic Kaddy Corp. of Ontario, Canada; the “Hillcrest SE” (or the “CaddieCommand” remote radio-guided steering system accessory, with all the components needed for converting the “Hillcrest AB”—a powered, but not remotely controllable, cart—into a remotely controllable cart) from Kangaroo Motorcaddies of Columbus, N.C.; and, the “RoboKaddy” from PowaKaddy International Ltd. of Sittingbourne, Kent, England. (Also see the following examples of patent document disclosures of carts that are battery powered and remotely controllable: U.S. Pat. No. 3,473,623 issued to Meek on Oct. 21, 1969 (shown on a reversed tricycle frame—with a pair of horizontally disposed wheel pivoting solenoids connected to either side of the non-drive rear steering wheel for pivoting it by alternate actuation of each solenoid, and noting that one or two electric motors may be substituted for the wheel pivoting solenoids); U.S. Pat. No. 3,742,507 issued to Pirre on Jun. 26, 1973 (front wheel pivotable by steer motor); U.S. Pat. No. 5,137,103 issued to Cartmell on Aug. 11, 1992 (front wheel pivotable by steering motor with worm gear); U.S. Pat. No. 5,167,389 issued to Reimers on Dec. 1, 1992 (cart steerable by independent operation of rear drive wheels, each powered by a separate drive motor); U.S. Pat. No. 5,180,023 issued to Reimers on Jan. 19, 1993 (cart steerable similar to preceding Reimers patent); and, U.S. Pat. No. 5,265,686 issued to Machen on Nov. 30, 1993 (front wheel pivotable by steering motor turning another wheel that engages a platform connected to front wheel fender).)

Some of the above-noted carts, particularly remotely controlled models, are provided with a stabilizing rear wheel on an arm that is, or can be, extended rearwardly (generally along the cart's centerline), apparently dedicated solely to help prevent the cart from tipping over backward while climbing sloped terrain.

It is believed that the present invention, which is described below, provides advantages that help make it possible to reduce the cost and improve the stability and controllability over previously known remotely controllable carts.

### SUMMARY OF INVENTION

As used throughout this specification, unless clearly indicated otherwise, the following terms have the definitions referred to or specified in this paragraph. Terms of direction, relative time, relative position, angular position, orientation, and shape are not intended to be limited to the exact direction, relative time, relative position, angular position, orientation, or shape referred to but are intended to be inclusive of approximations and substantial similarities to those directions, relative times, relative positions, angular positions, orientations, and shapes. The term “described or shown” is intended to include “described and shown.” The term “such as” is intended to suggest an example, without limitation to only that example. References to a thing being “within” something else are intended as references to the thing being at least partly within the something else. References to a thing moving “through” something else are intended as references to at least part of the thing moving through at least part of the something else. References to a thing occurring “while” something else occurs are not intended as a requirement that the thing be occurring for the entire time the something else occurs. The term “herein” is intended to include the drawings as well as the other sections of this specification (including the claims).

The present invention relates to an electric powered remotely controllable cart for carrying one or more golf bags wherein the cart has front-wheel drive and rear-wheel steering. It also relates to a method of steering a cart. (Although, this is not intended to limit the potential applications of the invention since it is also adaptable for use on other types of vehicles or for carrying other items).

According to one aspect of the invention, the cart comprises a frame having a front end and a rear end. It includes a drive wheel assembly and a steerable wheel assembly.

The drive wheel assembly is located at or near the front end. The drive wheel assembly comprises a drive wheel (preferably two of them) connected to a drive axle. It also comprises a housed drive coupling device, and a drive motor. (The housed drive coupling device can be a drive gearbox having a set of drive gears therein, or any other coupling mechanism that is suitable for communicating torque from the drive motor directly, or through an intermediary structure such as an axle, a clutch, and/or a transmission, to the drive wheel.) The drive motor is operably connected to the drive coupling device and the drive coupling device is operably connected to a drive axle for rotating the drive axle, and thus the drive wheel (typically at a much slower rotational speed than the rotational speed of the drive motor). The drive motor can be any electric motor capable of generating—while the motor is electrically energized by a cart power supply (e.g., a cart battery)—a torque and rotational speed deemed needed for moving the cart forward under predetermined load and terrain conditions. Preferably, the electrical connection to the cart power supply is via an electrical control device that enables operator control over the motor (also referred to herein as an electric motor control device) by manipulation of one or more operator input devices.

The steerable wheel assembly is located rearward from the location(s) of the drive wheel(s). (Preferably there are two steerable wheel assemblies, each substantially the mirror image of the other, with the location of each being rearward and laterally outward—one on the left and one on the right—from the location(s) of the drive wheel(s).) The steerable wheel assembly comprises a cart steering wheel, such as a rear wheel on the embodiments shown herein; and, a steering wheel support, such as a rear wheel support on the embodiments shown herein, rotatably connected to the steering wheel, preferably by connecting to the steering wheel's axle on each side of the steering wheel.

The steerable wheel assembly also comprises a pivot support connector for connecting the steerable wheel assembly to the cart frame (preferably to a rear leg). (Preferably, the pivot support connector includes a steering wheel pivot support for making a pivotal connection, e.g., via a pivot shaft, with the steering wheel support, and a connector block fixed to the steering wheel pivot support, for making the connection between the steerable wheel assembly and the cart frame, preferably to a rear leg.) The steering wheel support is pivotally connected to the pivot support connector, for the steering wheel support to pivot relative to the pivot support connector about a pivot axis. The steering wheel axle, and thus the steering wheel, pivots about the pivot axis in response to pivotal movement of the steering wheel support about the pivot axis. (Preferably, the steering wheel and steering wheel support form what is generally referred to as a caster—sometimes called castered—wheel with the steering wheel support having an upwardly extending pivot shaft that is received by the pivot support connector, with the axis of the pivot shaft serving as the pivot axis.) Preferably, and typically in the case of a castered wheel, the pivot axis is offset from, and thus does not pass through, the steering wheel's axle.

The steerable wheel assembly further comprises a steering motor and a steering gear. The steering motor is coupled to the steering gear (preferably through a steering motor gearbox for reducing the rate of rotational movement—e.g., motor shaft speed—generated by the steering motor), for transmitting at least some torque and rotational movement generated by the steering motor to the steering gear. The steering gear pivots in response to the rotational movement transmitted to it from the steering motor. The steering gear is connected to the steering wheel support for the steering wheel support to pivot in response to pivotal movement of the steering gear.

The steerable wheel assembly also comprises an electrically activatable center-lock device (such as a solenoid or any other electrical—which includes electromechanical and electronic—device capable of retracting or extending a plunger, preferably one in the shape of a rod but not limited to that shape, in response to the device being electrically energized or de-energized). The center-lock device is positioned proximate to a plunger receptor (preferably in the form of a sector of an annular plate) that has at least one plunger hole in it (as further discussed below). The plunger receptor is connected to the steering gear for the plunger receptor to pivot in response to pivotal movement of the steering gear and for the steering gear to not pivot while the plunger receptor is held in place relative to the center-lock device. The center-lock device has a plunger (again, preferably in the shape of a rod but not limited to that shape) that can be retracted and extended away from and toward the plunger receptor (and preferably is biased, such as by a spring, in one of those directions). The plunger receptor has at least one plunger hole in it (which hole need not necessarily pass all the way though the steering gear, in which case the plunger hole may simply be a cavity) for receiving at least part of the plunger, wherein the plunger hole is at a centering location on the plunger receptor. (Preferably, the plunger receptor and the steering gear are combined and made as a single component, such as a steering gear with the plunger hole(s) located in it, making the steering gear both a plunger receptor and a steering gear—in which case, the steerable wheel assembly is still considered to comprise a plunger receptor as well as a steering gear even though the plunger receptor is not a separate piece.) The centering location is the location on the plunger receptor (the steering gear, if the plunger receptor and steering gear are consolidated) that aligns the plunger hole with the plunger rod when the pivotal direction of the steering wheel is correct for straight-ahead movement of the cart, which pivotal direction of the steering wheel is also referred to herein as a centered direction. Pivotal direction is an object's angular orientation within a pivot plane—a plane perpendicular to the axis about which the object pivots (which, with regard to the steering wheel, is not to be confused with the axis about which the steering wheel rotates—that axis being the centerline of the steering wheel axle). If the steering wheel is pivotable through 180 degrees such that it can have two centered directions, then the centered direction referred to herein is the one of those two centered directions selected as the reference centered direction, preferably the one typically pointing generally forward in normal use of the cart.

And, preferably, the steerable wheel assembly comprises a self-centering device that responds to pivotal displacement of the steering wheel from the centered direction and biases the steering wheel to pivot toward the centered direction, such as by biasing the steering wheel support to pivot toward its neutral direction. The neutral direction for the steering wheel support, as is the neutral direction for each of the other components whose pivotal directions are correlated to the pivotal directions of the steering wheel, is that component's pivotal direction for the steering wheel to be in the centered direction.

According to this aspect of the invention, it includes a battery holder for the cart to carry a cart battery, the cart battery providing a source of electrical power (sometimes referred to as power supply unit or simply power supply) for electrical operation of the cart. Preferably, the cart battery provides the source of electrical power for the drive motor and for all of the other electrical devices aboard the cart (such as the steering motor, the center-lock device, and the onboard electrical control devices utilized for controlling the operation of one or more of the drive motor, steering motor, and center-lock device. Although, alternatively, some of the electrical devices aboard the cart could utilize different sources of power, such as other batteries.) And, preferably, the battery holder is connected to the cart at a location wherein the center of gravity of the installed cart battery is forward of the axis of the drive wheel axle (also referred to herein as drive axle) while the cart is in an operational configuration on a level surface. (The cart battery is “installed” while it is in the battery holder. “In the battery holder” means in the place provided by the battery holder for carrying the cart battery during normal use of the cart, even if that place is a simple platform without sides; and, therefore, does not require that the cart battery be enclosed, wholly or partially, by the battery holder. And, “an operational configuration” of the cart is a configuration for its normal use of carrying and moving a golf bag on a golf course, which would be an unfolded configuration of a cart that is foldable for, e.g., transport and/or storage.) Such location of the cart battery makes use of the battery's weight to increase drive wheel traction and to help prevent the cart from tilting backward.

The steering motor is electrically connectable to a steering motor power source (preferably the steering motor power source is the cart battery, although, as noted above, it could be any other source of electrical power suitable for powering the steering motor) wherein the steering motor, while so connected, is controllable (at least capable of being turned “on,” electrically energized; turned “off,” electrically de-energized; or both) in response to activation of an operator input device for steering the cart. For example, the connection may be a conventional electric motor power circuit (the steering motor's power circuit) that is connectable to the cart battery, if that is the power source for the steering motor, by connecting a set of battery cables (positive and negative cables) to the cart battery, with the steering motor's power circuit electrically coupled via an electrical control device, such as a relay, to an operator input device for steering the cart, wherein the electrical control device responds to activation of the operator input device by closing or opening (or by alternating between closing and opening—depending on the electrical control device's operational characteristics) the steering motor's power circuit. It should be appreciated, that this example is not intended as a limitation on the type or form of electrical control device(s) that can be used for electrically energizing or de-energizing the steering motor. (Note that, as used herein, “electrically coupled,” is not limited to couplings that include a non-physical (wireless) portion, such as an inductive or capacitive portion; and, as used herein, “electrically connected” and “electrical connection,” are not limited to connections that are strictly physical. As a result, the terms are used interchangeably herein.)

The steering motor generates torque (the level of said torque not necessarily being constant) while it is energized (i.e., electrically energized) and ceases producing said torque when it is de-energized (i.e., not electrically energized). Preferably, the steering motor is a bi-directional electric motor that can hold a position while continuing to generate torque—such as a conventional servo motor or step (sometimes called “stepper”) motor—or, alternatively, that can be energized for a particular length of time. A relay that can be energized for a particular length of time may be, for example, a relay that (by itself or with another relay) acts as a normally-open timed-open (NOTO) relay or a one-shot normally-open relay, which closes the steering motor's power circuit to energize the steering motor and then, after a set time delay following de-energizing the NOTO relay or after a set time following the original energizing of the one-shot normally-open relay, opens said power circuit to de-energize the steering motor. (Or, as another possible alternative, a relay may be utilized that can automatically de-energize itself after being energized—e.g., after a shaft, such as the steering motor's shaft, has rotated a predetermined number of degrees, which may be more than 360 degrees.)

According to this aspect of the invention, the center-lock device pulls (retracts) the plunger into a retracted position while the center-lock device is energized and ceases such pulling, thereby allowing the plunger to move to an extended position, while the center-lock device is de-energized. The steering motor and center-lock device are electrically coupled with one another (such as, for example, by each of them being electrically coupled to the same operator input device, being energized and/or de-energized by the same relay, and/or being electrically connected to one another via a common electrical connection) wherein the center-lock device is energized at substantially the same time the steering motor is energized in response to activation of an operator input device for steering the cart. (As used herein, “at substantially the same time” is inclusive of both (1) at the same time and (2) within a time delay period predetermined as needed or desired to avoid the steering motor or center-lock device jamming or otherwise preventing the other from operating as intended.) As noted above regarding this aspect of the invention, while the center-lock device is de-energized, the plunger is allowed to extend, and either remain in the plunger hole, if it is already there, or, if it is not already there, enter the plunger hole upon coming into alignment with it. Pivotal movement of the steering gear is impeded while the plunger is in the plunger hole—whether the steering wheel is being urged to pivot by, for example, the steering motor or a sloped surface. And, while the center-lock device is energized, the plunger is retracted and while retracted does not prevent the steering gear from pivoting in response to rotational movement generated by the steering motor.

The steering motor generates rotational movement (the rate of the rotational movement not necessarily being constant) in response to the steering motor being energized (unless the steering motor is holding a position) and ceases generating said rotational movement when the steering motor is de-energized. (Preferably, as noted above, the steering motor is a type that can hold a position—in which case, it will not necessarily generate rotational movement throughout the entire time it is energized since it will not rotate while holding the position. The steering motor may even be a type that can lock into and hold a position while it is de-energized pending, for example, being re-energized.)

When the steering wheel pivots (preferably, as noted above, with assistance of a self-centering device) to the centered position, the plunger is aligned with the plunger hole at the centering location. And, according to this aspect of the invention, with the center-lock device de-energized, the plunger is not prevented by the center-lock device from entering the plunger hole (preferably, the center-lock device is configured and oriented for the plunger to drop downward and for such movement to be assisted by a biasing device such as a spring). While the plunger is in the plunger hole at the centering location, the steering wheel is prevented from pivoting away from the centered position, thus helping to keep the cart on a straight track even while on a side sloping surface.

And, according to this aspect of the invention, it preferably includes a remote control and a receiver. The remote control would have onboard it at least one operator input device for steering the cart (for commanding the cart to turn—to change the cart's direction of travel relative to a straight-ahead direction toward the right or the left). Preferably, the remote control has more than one operator input device. (An operator input device can be any device that is located aboard the remote control or aboard the cart and that is activatable by a human operator in order to input an electrical signal for commanding the cart to perform a particular operation, such as to steer the cart toward the right or left, to move the cart forward preferably at more than one speed setting, or to stop the cart.)

The remote control preferably has an onboard remote-control source of electrical power (such as a battery of the proper size and electrical characteristics for operation of the remote control, which, depending on the particular remote control unit selected, may be, for example, a conventional 9 volt battery, one or more AA size batteries, one or more AAA size batteries, or any other suitable battery or set of batteries; or, instead or in addition, any suitable alternate device that provides a source of electrical power such as one or more solar cells) to provide power for operation of the remote control.

In accordance with this aspect of the invention, the remote control is capable of generating a wireless command signal in response to activation of the operator input device, the wireless command signal having characteristics reflecting the command associated with the operator input device. The receiver is able to receive and discern the characteristics of the wireless command signal (such as by being compatible with and properly tuned to the remote control) and to respond to the wireless command signal by communicating an electrical control signal (which may be wired or wireless) to the electrical control device (which, again, may be as simple as a relay) for controlling the steering motor in accordance with the command represented by the wireless command signal (such as closing the steering motor's power circuit to turn it “on” or opening said power circuit to turn it “off”). And, as already mentioned, the center-lock device is also energized, at substantially the same time as is the steering motor, in response to the activation of the operator input device. (Note that although many remote control transmitter-receiver combinations conventionally used for golf bag carts are radio transmitter-receivers, any other type of wireless-signal transmitter-receiver combination could be used, provided the receiver is compatible with and properly tuned for receiving and discerning at least one wireless signal generated from the remote controller. An alternative type of transmitter-receiver combination might be one that transmits and receives for example ultra sound, ultraviolet, infrared, light, microwave, or radar signals. And, although in some embodiments one or more relays may serve as the electrical control device(s) for controlling steering motors and center-lock devices; alternatively, any other electrical control device(s) useable for controlling the operation of the drive motor, steering motor and/or center-lock device may be used instead of and/or in addition to relays. Such other electrical control devices can be in the form of, for example, potentiometers, rheostats, solenoids, electric motor power (and/or speed) regulators, electric motor drive electronics, and/or electric motor controllers. The steering motor, center-lock device, and electrical control devices referred to herein, and the structure and operating characteristics of them, whether located on board the remote control or the cart, are believed to be well known by persons skilled in the art of making battery powered remotely controllable electric golf carts, and examples of such electrical control devices are believed to be commercially available in forms that interconnect and/or function as described or shown herein, or are readily adaptable to do so.)

As used herein, an operator-input device may be, but is not limited to being, in the form of any conventional human-operable switching or controlling mechanism—such as a dial (knob) type potentiometer or rheostat, a pushbutton, rocker, or toggle switch, or a joy stick—that the cart operator can activate to effect—such as via a relay or other electrical control device—turning an electric motor or a solenoid “on” or “off” or regulating it's speed or power. Included among such operator input devices are, in addition to those expressly described or shown herein that are manually activated, forms of operator input devices that have been or may be in the future developed for activation by other than manual methods, such as by an operator's voice, touch, or even proximity.

Usually, even in a cart that, although electrically powered, is not remotely controllable, there would be at least two operator input devices, e.g., at least one to switch the cart drive motor “on” and “off,” and at least one to vary its power output (in effect, its speed, and thus the speed of the cart, which, of course, is also influenced by the load imposed on the drive motor by the loaded cart and the terrain). Generally, such non-remotely controllable carts provide for manual control of the drive motor by electrically connecting (electrically coupling) the operator input device to an electrical control device (for example, a relay or a speed control device such as a rheostat, power regulator, motor drive, or motor controller).

In regard to the above-mentioned aspect of the invention, wherein it is a remotely controllable cart, the remote control preferably will have more than one operator input device for operating its steering motors and center-lock devices, e.g., one for steering the cart to the right and one for steering the cart to the left. Sometimes, however, one operator input device for steering the cart may be sufficient if it is able to perform the functions of two or more operator input devices, such as may be the case in an on-and-off pushbutton, a rocker switch, or a joy stick; in which case the single operator input device generally is able to send distinguishable signals—or the same signal in distinguishable sequences or patterns—to represent different commands. And, preferably the remote control also includes operator input devices that perform at least some of the functions performed by operator input devices found onboard non-remotely controllable electrically powered carts (usually on the cart's handle), such operator input devices for turning the drive motor “on” and “off” and/or varying the cart's speed. Of course, optionally, the remotely controllable cart may have operator input devices onboard the cart (e.g., on the cart handle) that perform at least some of the functions relating to steering that are performed by the operator input devices found onboard the remote control.

Thus, optionally, the steering motor and/or the center-lock device can be electrically coupled to operator input devices located onboard the cart in a manner similar to their coupling with operator input devices located onboard the remote control—but without necessarily having a wireless section to the coupling. If the coupling with a cart-bound operator input device does include a wireless section, the same receiver used with the remote control could be used for receiving transmissions from a separate cart-bound transmitter unit, provided the receiver is compatible with and properly tuned to the cart-bound transmitter unit. Of course, if the remote control is removably attachable to the cart, it could serve as both the cart-bound transmitter unit while attached to the cart and as the remote control while detached from the cart.

And, optionally, the plunger receptor may have one or more additional plunger holes in it, wherein each additional plunger hole is at a position that is angularly offset from the centering location. (Such a position is also at a radial distance from the pivot axis of the plunger receptor for the offset plunger hole to align with the plunger at some point during the pivotal movement of the plunger receptor.) Such an additional plunger hole thus provides a hole for the plunger to enter, while the plunger is being allowed (or forced) to extend, and to thereby hold the steering wheel in a steered direction—a pivotal direction of the steering wheel that is correct for changing the direction of movement of the cart—until the center-lock device retracts the plunger.

And a separate operator input device can optionally be included on the remote control (or on the cart) for energizing the center-lock device independently of the steering motor (which may be done, for example, by coupling the separate operator input device with a relay capable of closing the power circuit for the center-lock device without also closing the power circuit for the steering motor). By including this optional separate operator input device, the operator would be able to free the steering wheel (except for residual resistance, such as resistance from the de-energized drive motor and the self-centering device) to swivel in response to manual steering (e.g., by the operator manipulating the cart handle) while the cart is not being remotely controlled.

Of course, the center-lock device discussed above could, optionally, be replaced by one with reversed operational characteristics, i.e., one that retracts the plunger while the center-lock device is de-energized (rather than while it is energized) and extends the plunger—or allows it to extend—while the center-lock device is energized (rather than while it is de-energized). In which case, the discussion above with regard to the electrically coupled operation of the center-lock device and the steering motor would still apply but with the obvious adjustments made to indicate the electrical coupling is modified to provide for reversing the energized/de-energized relationship between the center-lock device and the steering motor. Reversing this relationship may be accomplished by, for example, the center-lock device and the steering motor each being electrically coupled to a relay that closes one power circuit at substantially the same time it opens the other, for the center-lock device to be oppositely energized and de-energized from the steering motor. And, if provision for freeing the steering wheel to swivel were included in a cart having this reversed relationship between the center-lock device and the steering motor, the separate operator input device for freeing the steering wheel (discussed in the preceding paragraph) could be coupled with a relay capable of opening (rather than closing) the power circuit for the center-lock device without also opening (rather than closing) the power circuit for the steering motor.

A brief summary of one aspect of the invention relating to a method for steering a cart is, for example, as follows. Generating a command signal for pivoting a steering wheel on a cart. Retracting a plunger from a plunger hole in a plunger receptor in response to the command signal. Generating rotational movement in response to the same or another command signal and transmitting at least some of the rotational movement to a steering gear. Pivoting a plunger receptor away from a neutral direction. Pivoting the steering wheel away from a centered direction. Allowing or forcing a plunger to extend toward the plunger receptor. Ceasing the generation of the rotational movement. Pivoting the plunger receptor toward the neutral direction. Pivoting the steering wheel toward the centered direction. Allowing or forcing the plunger to enter a plunger hole. Holding the steering wheel against pivoting. And, optionally, generating a subsequent command signal for stopping the pivoting of the steering wheel (which subsequent command signal may be, for example, simply the cessation of generating the command for pivoting the steering wheel and/or the automatic opening of a circuit by a timing device such as a time-delay relay—for example a NOTO relay or a one-shot normally-open relay). And, also optionally, using the steering motor for holding the steering wheel against pivoting.

It should be understood that the foregoing summary of one or more aspects and/or embodiments, or any of their parts, is not intended to limit any of the claims, which are based on the overall disclosure herein and limited only by the claims themselves and their equivalents. The present invention is intended to include all aspects, embodiments, and uses of it that are consistent with the disclosures herein, without limitation to the specific aspects and embodiments described or shown. (In this regard, for example, the invention is not limited to only being applied to golf bag carts, since the invention can be readily adapted for application to other types of vehicles.)

### BRIEF DESCRIPTION OF THE DRAWINGS

The present invention will be more clearly understood by reference to this specification in view of the accompanying drawings, in which:

FIG. 1 is a right side perspective view of a golf bag cart (cart) representing a preferred embodiment of features of the invention.

FIG. 2 is a front view of the handle and the upper portion of the handle-bearing arm of the embodiment seen in FIG. 1.

FIG. 3 is a right side perspective view of the embodiment seen in FIG. 1, showing the cart in a folded (collapsed) condition without the golf bag and without the battery (electrical power source).

FIG. 4 is a front view of the lower central portion of the embodiment seen in FIG. 1, without the battery holder (or battery) and without the golf bag or bag straps.

FIG. 5 is a right side perspective view of the lower right rear portion of the embodiment seen in FIG. 1, showing its right steering wheel oriented in a centered direction.

FIG. 6 is a right side perspective view of the rear portion of an embodiment similar to the embodiment seen in FIG. 1 but with an alternative steerable wheel assembly, showing its right steering wheel oriented in a centered direction.

FIG. 7 is a top view of the portion of the embodiment seen in FIG. 5, showing the right steering wheel oriented in a centered direction.

FIG. 8 is a top view of the portion of the embodiment seen in FIG. 7, showing the right steering wheel oriented in a left-turn direction (pivoted clockwise for effecting a left turn by the cart while it is moving in a generally forward direction).

FIG. 9 is a top view of the portion of the embodiment seen in FIG. 7, showing the right steering wheel oriented in a right-turn direction (pivoted counter-clockwise for effecting a right turn by the cart while it is moving in a generally forward direction).

FIG. 10 is a right side view of the portion of the embodiment seen in FIG. 5.

FIG. 11 is a partial view of FIG. 10, shown at a closer distance.

FIG. 12 is a block diagram of relationships between electrical components shown in FIG. 1.

FIG. 13. Is a block diagram showing a magnified partial view of, and addition of a time-delay feature to, the embodiment shown in FIG. 12.

### DETAILED DESCRIPTION OF PREFERRED EMBODIMENTS

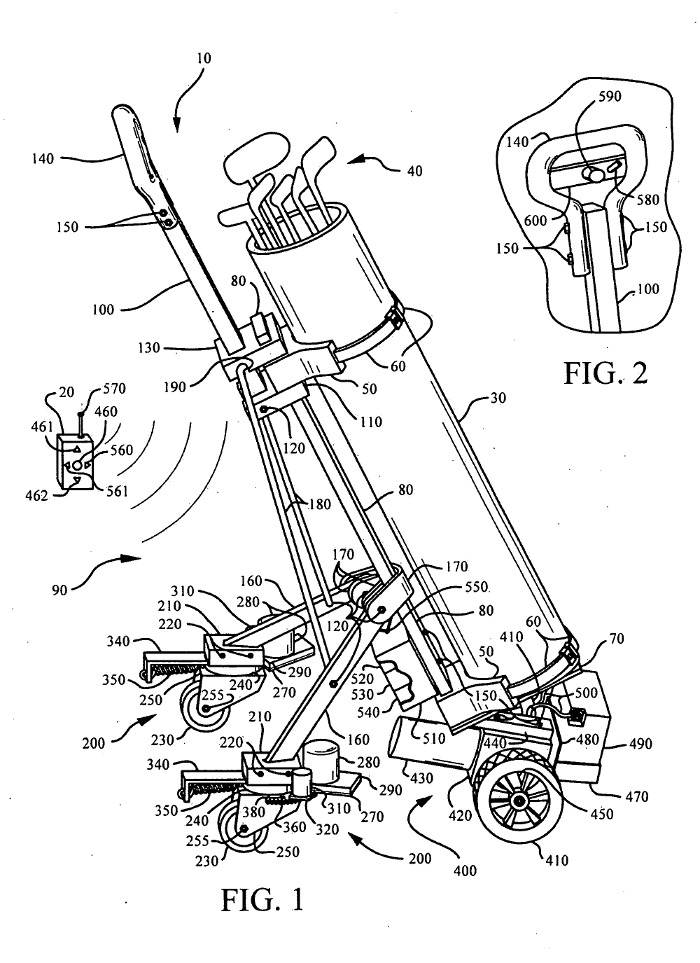

Referring to the drawings, FIG. 1 illustrates an embodiment of the present invention in the form of a foldable (collapsible) golf bag cart 10 with a remote controller 20. To illustrate a typical use, FIG. 1 shows the cart 10 carrying a golf bag 30 containing a few golf clubs 40. The bag 30 is shown held in place by two bag holder cradles 50, each having a pair of bag holder straps 60, with the bag prevented from slipping downward by a bag bottom support 70. The cradles 50 and bottom support 70 are shown attached to the front leg 80 of the tripod-like frame 90 of the cart 10.

The front leg 80 is shown in FIG. 1 connected to a handle arm 100 via a handle arm bracket 110 that permits the handle arm 100 to pivot downward (counter-clockwise in the view shown in FIG. 1) about the axis of a pivot connection 120 between the arm bracket 110 and the arm 100. (As used herein, a pivot connection 120 is a connection wherein a part is pivotally connected to one or more other parts by, for example, a loosely secured bolt, rod or pin with a nut, cotter pin, or other conventional locking device on one or both ends to prevent it from inadvertently working free from the part or parts it is connecting together—one of which may be the bolt, rod or pin itself). The handle arm 100 is shown in FIG. 1 in its operational (unfolded) position and secured in place by a movable bracket 130 through which, in the version shown, the arm 100 and top of the front leg 80 pass. At the distal end of the arm 100 (the end extending upward and rearward from the movable bracket 130), FIG. 1 shows a handle 140 fixedly attached to the arm 100 by bolts 150. (As used herein, a fixed attachment can be made between parts by any method or device that connects the parts together to prevent, while so connected, any significant relative movement between them, such as by conventional welding, adhesives, bolts, or screws.)

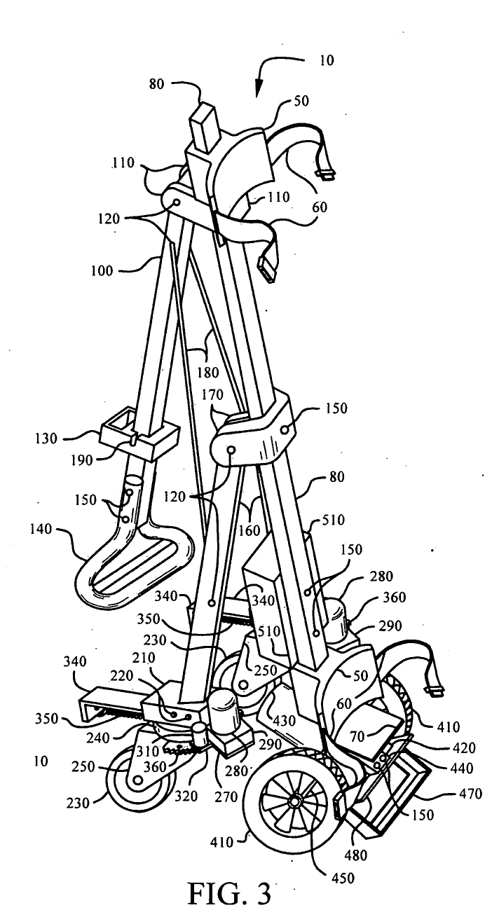

The frame also is shown in FIG. 1 with two rear legs 160 that are substantially mirror images of one another, each shown held in its unfolded position by being pivotally connected (by pivot connections 120) to a front leg strap 170 that is fixedly attached to the front leg 80 and to a support rod 180 that is pivotally connected at its other end to the arm 100 where it can be received into a groove 190 in the movable bracket 130 for securing the arm 100. (Although not shown, the movable bracket 130 also has a groove on its left side similar the groove 190 shown on its right side. And, although the pivot connections 120 of the support rod 180 to the arm 100 are not visible in FIG. 1, their locations are shown in FIG. 3.)

FIG. 1 shows two steerable wheel assemblies 200, each having a connector block 210 which is fixedly attached (using screws 220) to the bottom of each rear leg 160, each steerable wheel assembly 200 being substantially the mirror image of the other. Although, alternatively, the attachment between the connector block 210 and the rear leg 160 could be made flexible by, for example, using only one screw 220 (or one coaxial pair of opposed screws 220) and allowing at least some rotation about the axis of that screw (or coaxial pair of screws). (Of course, screws 220, bolts 150, and other conventional connectors suitable for the same purpose may be substituted for one another.)

The steerable wheel assembly 200 includes a steering wheel 230 and other components (discussed below), some of which connect the steering wheel 230 to its corresponding rear leg 160 and some of which, in response to the controlled provision and/or interruption of electric power (also referred to as electric energy) to them, make the steering wheel 230 steerable. (As used herein the term “wheel” includes the wheel's tire, if the wheel has a tire.) The steerable wheel assembly 200 in the embodiment of the cart shown in FIG. 1 includes the following components (other than the rear leg 160, which is considered to be part of the cart frame 90).

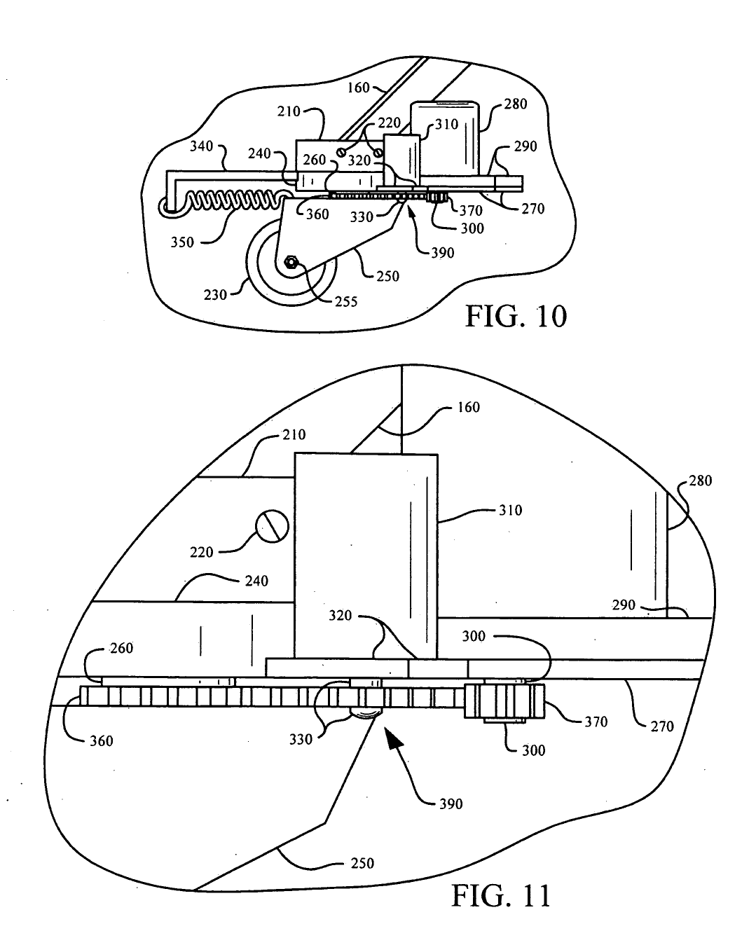

As shown in FIG. 1, the rear leg 160 interfaces with the connector block 210 at a somewhat complex angle since, in that embodiment, the rear leg 160 is a straight support piece extending from its pivot connection 120 at the leg strap 170 toward the connector block 210 in a downward, rearward, and outward direction. A cylindrical steering wheel pivot support 240 is shown in FIG. 1 fixedly attached to the bottom of the connector block 210. (The combination of the steering wheel pivot support 240 and the connector block 210 form a pivot support connector which, alternatively, could be made as a single component.) The wheel pivot support 240 is pivotally connected to a steering wheel support 250 (sometimes called a fork or yoke support) via a steering wheel pivot shaft 260 (not visible in FIG. 1 but shown in FIGS. 10 and 11), with the steering wheel support 250 shown rotatably connected to the steering wheel axle 255. The steering wheels 230 together with their steering wheel supports 250 and steering wheel pivot shafts 260, are shown in FIG. 1 as castor-type wheels (with the steering wheel axle 255 located to the rear of the centerline of the steering wheel pivot shaft 260). However, alternatively, use can be made of any type of wheel and wheel support combination that is pivotally controllable using substantially the same means described or shown herein for controlling the steering wheel's direction. And, a steering motor support plate 270 is shown fixedly attached to the pivot shaft support 240 (although, alternatively, the support plate 270 may be attached instead, or in addition, to the connector block 210).

FIG. 1 shows a steering motor 280 (which can be, for example, any conventional, preferably bi-directional, electric motor that can operate to generate a predetermined amount of torque and rotational speed deemed desirable for its intended purpose as further described below) with the housing of the steering motor 280 fixedly attached to the top of a steering motor gearbox 290 (although, alternatively, the steering motor 280 and steering motor gearbox 290 can be made as a single component—e.g., contained within a single housing).

The steering motor 280 is operably coupled to the steering motor gearbox 290, which transfers at least some torque and rotational motion generated by the steering motor 280 to a steering gearbox shaft 300 (not visible in FIG. 1 but shown in FIGS. 10 and 11). The steering motor gearbox 290 preferably is a reduction gearbox that has a conventional arrangement of internal gears (not shown), which may include a worm gear, engaging one another to ultimately provide torque to the steering gearbox shaft 300 and to rotate the steering gearbox shaft 300 at a reduced rotational speed, relative to the rotational speed generated by the steering motor 280. Of course, the combination of steering motor 280 and steering motor gearbox 290 should be selected to achieve a steering gearbox shaft 300 torque and speed deemed suitable for pivoting the steering wheel 230 at a safe rate, such as a rate suitable for turning the cart 10 during its normal operation (e.g., while the cart is fully loaded and moving at its maximum intended forward speed over typical golf course terrain) without causing the cart 10 to tip over.

As shown in FIG. 1 the steering motor gearbox 290 is fixedly attached to the steering motor support plate 270. The steering motor support plate 270 has an opening through it (not shown) that is suitably sized and located to accommodate passage through it and rotation within it of the steering gearbox shaft 300.

A center-lock device is shown in the form of a steering solenoid 310 in FIG. 1, with its housing fixedly attached to a solenoid support plate 320, which solenoid support plate 320 is, in the configuration shown in FIG. 1, fixedly attached to the steering motor support plate 270. The solenoid support plate 320 has an opening through it (not shown) that is suitably sized and located to accommodate passage through it and vertical movement within it of a solenoid plunger rod 330, also referred to herein simply as plunger 330 (not visible in FIG. 1 but shown in FIGS. 10 and 11).

A self-centering device in the form of a tension support 340 and tension spring 350 is shown in FIG. 1. The tension support 340 is shown fixedly attached at its front end to the pivot support 240 (or, alternatively, to the connector block 210) with the rear end of the tension support 340 attached to the tension spring 350. FIG. 1 shows the other end of the tension spring 350 connected to the steering wheel support 250, at a point rearward of the steering wheel pivot shaft 260. As a result, tension on the tension spring 350 tends to pull the steering wheel support 250 toward its neutral direction, thus the steering wheel 230 toward its centered direction (the pivotal direction of the steering wheel for the cart to move straight-ahead), for helping to return the steering wheel 230 to the centered direction after it has been pivoted to the right or left by operation of the steering motor 280. (Alternatively, any other self-centering device could be used instead of the tension support 340 and tension spring 350 combination shown. For example, the tension spring 350 could be replaced with an elastic band, an elongate piece such as a bar that is laterally flexible and resilient, or a side-by-side pair of opposing tension springs or elastic bands. Or, both the tension support 340 and the tension spring 350 could be replaced with a coil spring or torsion bar connected at one end to the pivot support 240 or connector block 210 and at the other end to the steering wheel support 250).

The steerable wheel assembly 200 shown in FIG. 1 also has a steering gear 360 that is fixedly attached to the steering wheel support 250 (or, alternatively, to the pivot shaft 260 if the pivot shaft 260 pivots the steering wheel support 250). The steering gear 360 is engaged by a steering gearbox output gear 370 (not visible in FIG. 1 but shown in FIGS. 10 and 11) that is fixedly attached to the steering gearbox shaft 300. Thus, the steering gear 360 pivots, and thereby also pivots its associated steering wheel support 250 and steering wheel 230, about the pivot shaft 260 in response to rotation of the output gear 370. The steering gearbox shaft 300 rotates, as noted above, in response to operation of the steering motor 280. The steering gear 360 has at least one plunger hole 380 in it, suitably sized and located to accommodate insertion and vertical movement therein of the plunger 330. Preferably, the plunger hole 380 passes completely through the steering gear 360, but may, alternatively, pass only partially through it. And, preferably, the centerline of each plunger hole 380 is located along an imaginary arc that would be traced by a projection of the centerline of the plunger 330 on the steering gear 360 as the steering gear 360 is pivoted in response to rotation of the output gear 370. (Thus, a plunger hole 380 that comes into angular alignment with the plunger 330, such as by the pivoting of the steering gear 360, will also be vertically aligned—e.g., directly under—the plunger 330.) One plunger hole 380 is positioned in a centering location 390, which is a location on the steering gear 360 that is aligned with the plunger 330 when the steering wheel 230 is pointing in its centered direction (the pivotal direction of the steering wheel 230 that is for the cart 10 to move forward without turning to the right or to the left, in other words, the direction for straight-ahead movement of the cart 10). (The centering location 390 and its associated plunger hole 380, are not visible in FIGS. 1, 3, 5-7, 9-11, but are shown in FIG. 8 and indicated by implication in FIGS. 10 and 11, which show the location of the plunger 330 while it is retaining the steering gear 360 in its neutral direction.) The steering gear 360 shown in FIG. 1 (as well as in FIGS. 3 and 5-11) has plunger holes 380 in it so serves both as a plunger receptor and a steering gear, eliminating the need in this embodiment for a separate plunger receptor. As a result, references to the steering gear in connection with the figures provided herewith, are intended as references to both a steering gear and plunger receptor, which are consolidated into one part, the steering gear 360, in the embodiments shown herein.

The embodiment shown in FIG. 1 also includes a drive wheel assembly 400, located in the front portion of the cart 10, generally below the bag bottom support 70. The drive wheel assembly 400 is shown as including a pair of drive wheels 410, each being substantially the mirror image of the other (although this is believed preferable, another embodiment could utilize only one drive wheel or more than two drive wheels); a drive gearbox 420; and a housed drive motor 430. In FIG. 1, the drive gearbox 420 is shown fixedly attached by bolts 150 to a drive gearbox support 440. Preferably, the gearbox support 440 is the most forward (and lowest) portion of the front leg 80, which is upwardly bent a sufficient amount, relative to the main portion of the front leg 80, to accommodate the attachment to it of the drive gearbox 420 as shown in FIG. 1. (Of course, alternatively, the gearbox support 440 could be any other conventional support structure that can carry the drive gearbox 420 and all of the other components attached to it, and that can be attached to a sturdy part of the cart frame 90, preferably to the front leg 80.)

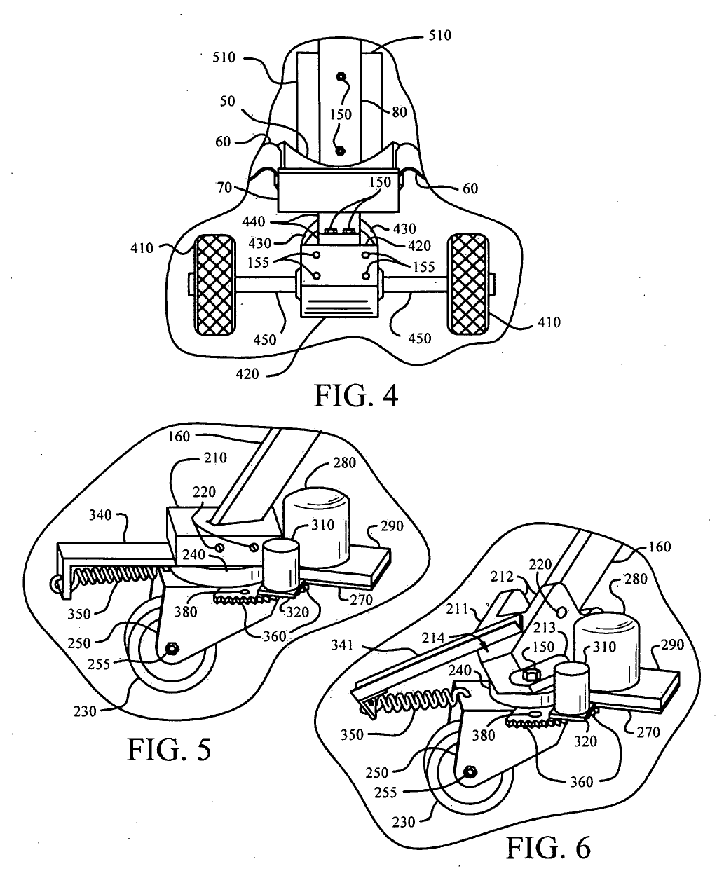

As shown in the embodiment shown in FIG. 1, the housing of the drive motor 430 is fixedly attached to the rear of the drive gearbox 420. (The drive motor 430 and drive gearbox 420 can be any conventional electric motor and any conventional gearbox that can be coupled together so that, while the motor is electrically energized in accordance with its specifications, the gearbox provides, at its output end, a level of torque and a rotational speed that are needed or desired as further discussed herein). The drive motor 430 is coupled via the drive gearbox 420 to each drive axle 450 which is connected to the drive wheel 410 on its respective side for rotation of the drive wheels 410 in response to rotation of the drive motor 430. The drive gearbox 420 preferably is a reduction gearbox capable of converting the torque and rotational speed it receives from the drive motor 430 to a higher torque and a reduced rotational speed for delivery via the drive axles 450 to the drive wheels 410. (The drive axle 450 on the left side is not visible in FIG. 1, or in FIG. 2 discussed further below, but is shown in FIG. 4.) The drive motor 430 and drive gearbox 420 are selected to deliver, through each drive axle 450, the combination (or combinations) of torque and rotational speed at each of the drive wheels 410 that are deemed needed to move the cart 10 in a manner consistent with its intended purpose—such as to move a fully loaded golf bag at approximately the walking speed of an average person, over typical golf coarse terrain. Preferably, the drive gearbox 420 includes a conventional worm gear (not shown).

The level of electrical energy delivered to, and thus the resulting levels of torque and rotational speed generated by, the drive motor 430 can be varied by operator-input devices for enabling the operator to exercise control over the cart's drive motor, thus over the cart's powered movement. The remote control 20 shown in FIG. 1 has three pushbuttons for that purpose: a go-stop button 460, a go-faster button 461 and a go-slower button 462. As may be evident from their names, the go-stop button 460 is for commanding the drive motor 430 to turn “on” with an initial activation and to turn “off” with a second activation, the go-faster button 461 is for commanding the drive motor 430 to increase its rotational speed based on how long (or how many times) it is activated, and the go-slower button 462 is for commanding the drive motor 430 to reduce its rotational speed also based on how long (or how many times) it is activated. Thus, because the drive motor 430 is coupled to the drive wheels 410 (or, alternatively, the single drive wheel in an embodiment having only one drive wheel), the operator is able to command the cart 10 to go (e.g., begin moving forward), go-faster, go slower, and stop. (Alternate embodiments may also include the ability to command the cart to move backward, with operator input devices and other controls available to command such reverse rotation and preferably with a bi-directional drive motor. Although such alternate embodiments are considered to be within the scope of the invention, it is believed that the cart can turn to avoid most obstacles and otherwise operate effectively without the need for it to be driven backward. Therefore, reference herein to the movement of the cart is, unless otherwise specified, directed to movement of the cart in a forward direction, or causing it to turn to the right or left of a forward direction. However, such references are not intended to limit the scope of the invention to exclude embodiments in which the drive motor can be commanded to drive the cart in a backward direction.)

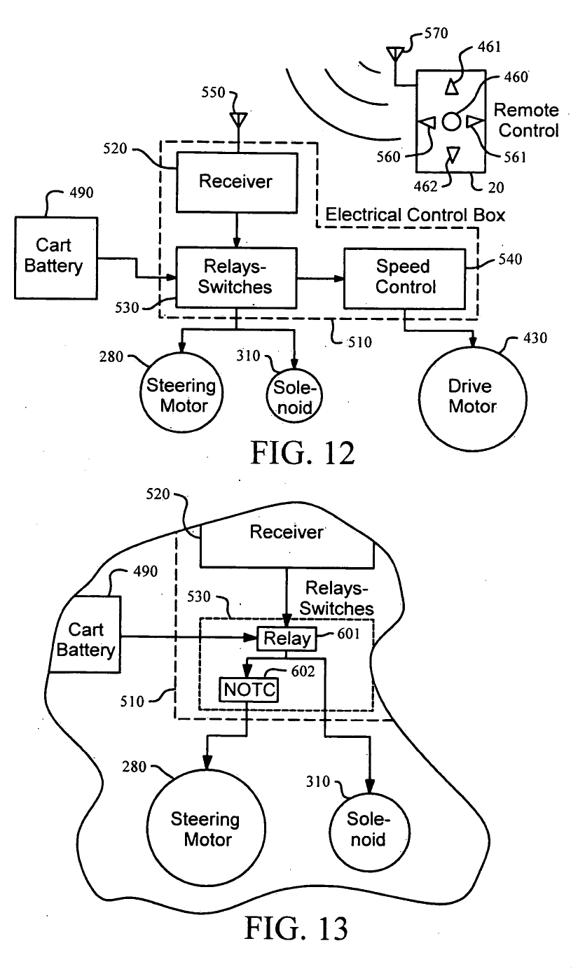

FIG. 1 shows a battery holder 470 fixedly attached via its back plate 480 to the front of the drive gearbox 420, at a position in front of the drive axles 450. In FIG. 1, a removable electric cart battery 490 is shown being held by the battery holder 470. Preferably the cart battery 490 is a conventional 12-volt vehicle battery designed for use on golf bag carts, although it could be any electric battery that is suitable for providing, through appropriate conventional electrical connections, the level of voltage and/or current required by the drive motor 430, the steering motors 280, and the steering solenoids 310, for their operation in accordance with their respective specifications. Electrical connections mentioned herein (including their associated wires) are not shown in the figures relating to this embodiment (with just a few generalized exceptions noted below) since the electrical connections are all conventional. It is believed that such conventional connections are well understood and readily made by persons reasonably skilled in the art of making electrical connections on remotely controllable golf carts, which connections may be made directly or via intermediary components, devices, circuits, or parts. Of course, a first component that is electrically connected to a second component (which may be a source of electrical power) is not considered disconnected merely by the opening of the circuit of which the electrical connection is a part, even if one or both of the components can be de-energized by the opening of said circuit. (The exceptions to not showing the electrical connections in the figures are the showing in FIG. 1 of a portion of the bundled pair of battery cables 500, with only one connection to the cart battery 490 visible; and, the showing in FIGS. 12 and 13 of symbolic electrical relationships between several electrical components, in the form of block diagrams to illustrate an example of such relationships in a very basic embodiment and in a small variation on it.)

Such positioning of the battery holder 470, accommodates placement of the drive wheel assembly 400 at the front part of the frame 90 as shown in FIG. 1. (Such placement of the drive wheel assembly 400 provides the cart with front-wheel-drive and frees the steering wheels 230 for use in steering the cart 10.) In addition, by positioning of the battery holder 470 in front of the drive axles 450, the cart battery 490 (while in the battery holder 470) contributes to the traction of the drive wheels 410 and helps to counterbalance the weight of the parts of the cart 10 located to the rear of the drive axles 450. (Note that, in the embodiment shown in FIG. 1, the weight of the cart battery 490 produces a first torque, about a line connecting the two steering wheels 230, and the first torque results in a downward (traction-enhancing) force to the drive wheels 410, so the weight of the cart battery 490 contributes to the traction as a result of the increase in the torque's moment arm—e.g., by an increase in the distance of the cart battery 490 in front of said line. The weight of the cart battery 490 in that position also produces a second torque, about the centerline of the drive axles 450, which produces—or at least contributes to—the counterbalancing effect. This counterbalancing effect tends both to reduce the load on the steering wheels 230, and to help counter any tendency the cart may otherwise have to tip over backward while climbing an inclined surface.)

FIG. 1 also shows an electrical control box 510 attached to the front leg 80 by a pair of bolts 150. The electrical control box 510 is shown in FIG. 1 with a section cut away, revealing that the electrical control box 510 acts as a container for the cart to carry a receiver 520, a relay-switch box 530, and a drive motor speed-control box 540. The electrical control box 510, and all of the electrical devices contained therein, can be electrically connected to the cart battery 490 for it to serve as their source of electrical power. The remote control 20 shown in FIG. 1 is capable of transmitting wireless radio signals and the receiver 520 shown in FIG. 1 is a radio receiver that is compatible with the remote control 20, being capable of receiving the radio signals transmitted by the remote control 20 via a receiver antenna 550, shown attached to the top of the electrical control box 510. The relay-switch box 530 houses the various relays (not shown in FIG. 1, but see FIG. 13 for an example of two relays, including their associated switches such as contacts, represented symbolically in block-diagram form) which are utilized in closing and/or opening electrical circuits (for energizing and/or de-energizing electrical devices such as steering motors 280, drive motor 430, and solenoids 310) in response to activation of the various operator input devices, as further discussed herein. The drive motor speed-control box 540 houses the drive motor's speed-control circuitry (not shown, but see FIG. 12 for an example of a simple illustration of the path of power and control signals to and controlled power from such circuitry, represented symbolically in block-diagram form), which can be any circuitry capable of providing some control over the on/off condition and/or speed (e.g., power) of the drive motor 430 in response to activation of an operator input device such as the go-stop button 460, go-faster button 461, and/or go-slower button 462, which circuitry may be in the form of, for example, a rheostat, motor speed (e.g., power) regulator, motor driver, or motor controller. The go-stop button 460, go-faster button 461, and/or go-slower button 462 are each coupled to the drive motor's speed control circuitry in the drive motor speed control box 540, in similar fashion to that described with regard to the right- or left-turn button 560,561 (see below) being coupled to the steering motor 280. The speed control circuitry in the speed control box 540 is alternately energized and de-energized by activations of the go-stop button 460, and said circuitry responds to activation of the go-faster or go-slower buttons 461,462 by increasing or decreasing the electrical power delivered from the cart battery 490 to, and thus the torque and speed generated by, the drive motor 430.

The receiver antenna 550 is electrically connected to the receiver 520. As also shown in FIG. 1, the remote control 20 includes a pair of pushbutton operator input devices for steering the cart (one right-turn button 560 and one left-turn button 561, sometimes referred to in the alternative as the right- or left-turn button 560,561). Activation of the right or left-turn button 560,561 communicates a right or left-turn command to the remote control 20 for it to generate a right- or left-turn command signal, which in this embodiment is a radio signal having a signature identifiable as representing the right- or left-turn command, for wireless transmittal via an onboard remote control transmitting antenna 570. Upon receipt of the right- or left-turn command signal, via the receiver antenna 550, the receiver 20 is able, assuming it is properly tuned and electrically energized at the time, to discern (such as via signal processing, integrated, and/or microprocessor circuitry conventionally used in remote-control receivers) the right- or left-turn command signal and in response communicate a right- or left-turn electrical control signal (via a wired connection or, alternatively, via another transmitter-receiver link) to a right- or left-turn relay (not shown in FIG. 1, but represented as a box labeled relay 601 in FIG. 13), preferably located in the relay-switch box 530. The, right- or left-turn relay (each also referred to herein as a steering relay), being electrically coupled with the circuit that carries the right- or left-turn electrical control signal (and thus being also electrically coupled with the receiver 520, the remote control 20, and the right- or left-turn button 560, 561), responds to the right- or left-turn electrical control signal by closing the steering motor's power circuit (an electrical power circuit, not shown except to the extent represented symbolically in block-diagram form in FIGS. 12 and 13, connecting the cart battery 490 with the steering motor 280). Preferably, continuous activation of the right- or left-turn button (e.g., holding it down) results in a continuous right- or left-turn command signal and thus in the steering motor 280 and solenoid 310 being energized until the right- or left-turn button is de-activated (e.g., no longer held down); and, preferably the de-activation results in cessation of the right- or left-turn command signal and thus in the steering motor 280 and solenoid 310 being de-energized (e.g., by the steering motor relay responding to the cessation of the right- or left-turn electrical control signal, which as noted is communicated by the receiver in response to the right- or left-turn command signal, by opening the steering motor's power circuit).

Perhaps the simplest, and believed preferable, setup is for the solenoid 310 to be electrically connected to the steering motor 280, such as by the solenoid's power circuit (not shown except to the extent represented symbolically in block-diagram form in FIGS. 12 and 13) being connected to the steering motor's power circuit (forming a common connection point—which of course is actually two points, one for positive and one for negative) between the steering motor 280 and the steering relay (relay 601, as shown in FIG. 13 but, in this setup, without the time-delay relay labeled NOTC 602), so that the steering motor 280 and solenoid 310 are energized and de-energized at the same times (i.e., so they are energized simultaneously and de-energized simultaneously, except of course for any—presumably insignificant—normal transmission time differences in the two power circuits). However, in an alternative setup, the solenoid 310 could be energized and/or de-energized at different times, although preferably only slightly different times, from when the steering motor 280 is energized and/or de-energized. A time differential between when the steering motor 280 and the steering solenoid 310 are energized may be achieved, for example, by placing a timing device, such as a time-delay relay, between one of the components and the above-mentioned common connection point (e.g., as in FIG. 13, which shows placement of the time-delay relay labeled NOTC 602 between the steering motor 280 and the common connection point). Or, for another example, by using a setup with the power circuits of the steering motor 280 and the solenoid 310 each being electrically connected to the cart battery 490 through separate relays (rather than the shared relay 601 for the common portion of their respective power circuits as shown in FIG. 13), so that each of the separate relays responds to the right- or left-turn electrical control signal communicated by the receiver 520 but with one of these separate relays functioning as a non-time-delay relay (such as relay 601) and the other separate relay functioning as a time-delay relay (such as NOTC 602) in order to achieve the time differential.

A different alternative setup may be preferred for energizing and de-energizing the steering motor 280 and the steering solenoid 310 where, for example, the steering motor 280 is not a type that can hold an angular position while remaining energized. This can be done by, for example, including an automatic-off timing device (not shown), such as a one-shot normally-open relay or a NOTO relay (both discussed further above), for opening the steering motor's power circuit after a predetermined time period (e.g., following the initial receipt or the termination of the right- or left-turn electrical control signal), the predetermined time period preferably being based on the amount of time that is deemed appropriate for the cart to make at least a minimal turn. (If this different alternative setup is employed, preferably, the automatic-off timing device also opens the solenoid's power circuit at substantially the same time as it does the steering motor's power circuit.) In this way, the plunger 330 can be allowed to enter a plunger hole 380 that is angularly offset from the centering location 390, for holding the steering wheel 230 in a non-centered direction (a pivotal direction of the steering wheel for the cart to turn while it moves). And, as another option, an additional relay (not shown, but one such as relay 601) in the steering solenoid's power circuit, that is responsive to an additional operator input device (not shown), could, optionally, be included for closing the solenoid's power circuit to keep the solenoid 310 energized, and thereby keep the plunger 330 retracted, while the steering motor 280 is de-energized, thus allowing the steering wheel 230 to swivel. (Any of the relays referred to herein may be in the form of a single multi-function relay having the functionality of each of the relays it is intended to comprise. And, any of the timing devices, such as time-delay relays, referred to herein may utilize electronic circuits (e.g., resistor-capacitor networks) as electronic-timer delays. Of course, references herein to relays and to particular types of relays are intended to be exemplary only and are not intended to limit the scope of the invention to only those types of relays or to only relays as timing devices or as electrical control devices. It is recognized that there are a multitude of types of relays, timing devices, and other electrical control devices that either alone or in combination with one or more other electrical control devices and/or electronic circuits can be used to achieve the purposes described or shown herein without deviating from the invention.)

Preferably, the steering motor 280 and solenoid 310 on the left side of the cart are electrically coupled with the right-turn button 560 and the left-turn button 561 in the same way as are the steering motor 280 and solenoid 310 on the right side of the cart, for them to respond to activation of the right- or left-turn button 560,561 at substantially the same time. That is to say, it is preferable for the steering wheel 230 on the left side and the steering wheel 230 on the right side to be acted upon substantially simultaneously to pivot in the same direction and/or hold the same pivotal direction.

FIG. 2 shows an example of operator input devices for controlling the drive motor (a drive motor on-off toggle switch 580 and a drive motor speed control dial 590) mounted on the cart 10, supported by control bar 600 attached to the cart's handle 140. The toggle switch 580 performs the same operator input functions from the cart 10 as does the go-stop button 460 from the remote control 20. The speed control dial 590 (preferably a rotatable potentiometer) performs the same operator input functions from the cart 10 as do the go-faster button 461 and the go-slower button 462 from the remote control 20. The toggle switch 580 and speed control dial 590 preferably are electrically coupled to the drive motor control circuitry in the speed control box 540 in substantially the same manner as are their respective counterpart operator input devices on the remote control 20, without of course the need for the intervening wireless transmitting and receiving devices.

FIG. 3 shows, in a folded configuration of the embodiment of the cart shown in FIG. 1, the placement of the battery holder 470 on the front of the drive gearbox 420 and front of the drive gearbox support 440, which results in the battery holder 470 being positioned mostly forward of the bag bottom support 70, and well in front of the drive axle 450. All of these relative positions are more clearly seen without the presence of the bag 30. And the relatively forward position of the battery holder 470 is evident in FIG. 3 even with the cart 10 folded as shown, which actually shows the battery holder 470 rotated about the drive axle 450 into a position closer (horizontally) to the drive axle 450 than it would be in the unfolded configuration shown in FIG. 1. FIG. 3 also illustrates that the cart 10 can be made to fold into a compact size for, e.g., transport and storage, even with the steering motor 280, the steering gear box 290, the solenoid 310, and the steering gear 360 located primarily forward of the rear legs 160. It can also be seen in FIG. 3 that the off-center orientation of those components enhances the foldability of the cart 10.

In FIG. 4, The arrangement of the drive wheel assembly 400 (on the cart 10 in its unfolded configuration) is shown in this front view, with the battery holder 470 removed. The symmetry of the cart's component parts about a vertical plane that bisects the right half of the cart 10 from its left half is quite evident in FIG. 4. As a result of that symmetry, the components, and halves of components where the bisecting plane runs through them, on the right side of the cart 10 have identical mirror image twins on the left side of the cart 10, except for differences that may appear, although not in FIG. 4, in the loosely hanging bag holder straps 60, which differences are not considered significant with regard to the discussions herein. Thus, in this and the other figures, each component of a mirror-image set of twins is identified by the same reference number. The two front drive wheels 410 in this embodiment are each shown connected to the centrally located drive gearbox 420 by a pair of drive axles 450, one on the right side of the cart 10 (appearing on the left in the front view shown in FIG. 4) and one on the left side of the cart 10 (appearing on the right in FIG. 4). As noted in the discussion relating to FIG. 1, preferably the drive gearbox 420 includes a worm gear (not shown) to help reduce the size and weight of the drive gearbox 420. The drive gearbox 420 shown in FIG. 4 is operably engaged with each drive axle 450 to rotate both drive axles 450, and thus both drive wheels 410, at substantially identical rotational speeds. One or both of the drive axles 450 could be connected to the gearbox 420 (or to the gears housed by it) through any mechanism that allows one drive wheel 410 to rotate at a different rotational speed (or not to rotate at all) relative to the rotational speed of the other drive wheel 410 (for example, a conventional differential or clutch). However, it is believed that this is an option, and not a necessity, since it is believed that the pivotal control of the two steering wheels 230 can provide sufficient turning moment to overcome most tendencies of an abreast pair of jointly driven drive wheels 410 to track straight-ahead. FIG. 4 further shows the positioning of the battery holder 470 (again, it is removed and not present in FIG. 4) by virtue of the locations of the four bolt holes 155 shown on the front face of the drive gearbox 420 for bolting the battery holder back plate 480 to the drive gearbox 420. Thus, FIG. 4 illustrates the front and low location for the cart battery 490 (thus for the battery's center of gravity) when the battery holder 470 is attached and the cart battery 490 is installed therein.

FIG. 5 shows a right side view of the steerable wheel assembly 200 on the right side of the cart 10. In that figure, a number of components discussed in regard to FIG. 1 can be seen more clearly. The steering wheel 230 is shown in the centered position. Thus, assuming the solenoid 310 is de-energized, the plunger 330 (not visible in FIG. 5, but shown in FIGS. 10 and 11) should be in an extended configuration, e.g., protruding downward from the bottom center of the solenoid 310. The steering gear 360 and the steering wheel 230 are coupled via the steering wheel support 250 for all of them to pivot together about the centerline of the steering wheel pivot shaft 260 (not visible in FIG. 5, but shown in FIGS. 10 and 11). The steering gear 360 shown in FIG. 5 has plunger holes 380 in it (only one of which is visible in FIG. 5) with one of the plunger holes 380 positioned at the centering location 390 (not visible in FIG. 5, but shown in FIG. 8). With the steering gear 360 in the pivotal direction shown in FIG. 5, the plunger 330 is aligned with the centering location 390 and, if extended, would be in the plunger hole 380 at the centering location 390 (the plunger hole 380 at the centering location 390 is not visible in FIG. 5, but is shown in FIG. 8). The steering gear 360 is thus held, and it holds the steering wheel 230 in the centered position (e.g., for straight-ahead movement of the cart 10), until the plunger 330 is retracted by operation of the solenoid 310 when the solenoid 310 is energized. As discussed elsewhere herein, in an alternate embodiment, the solenoid 310 (or other center-lock device) might be one that extends its plunger 330 while the solenoid 310 is energized instead of while it is de-energized. So, for such an alternate embodiment, the solenoid 310 would be energized, rather than de-energized, in order to extend its plunger 330 into the plunger hole 280 at the centering location 390 and would be de-energized, rather than energized, in order to retract the plunger 330.

FIG. 5 shows a plunger hole 280 at an angular position on the steering gear 360 that is offset from the centering location 390. Having a plunger hole 280 positioned at a location angularly offset from the centering location 390 may be useful where, for example, the operator wishes to use the solenoid 310—instead of, for example, torque generated by the steering motor 280—to hold the steering wheel 230 in a non-centered direction.

As shown in FIGS. 1, 3, 5, 10, and 11, the steering motor 280 is attached to, and is operably engaged (although such engagement is not visible) with, a steering motor gearbox 290 for the steering motor gearbox 290 to deliver torque and, if any, rotational speed generated by the steering motor 280, to the steering gear 360. (Preferably, the steering motor gearbox 290 is a reduction gearbox that can deliver a much lower rotational speed than it receives from the steering motor 280.) In the embodiments shown in the figures, the pivotal direction of the steering wheel 230 is correlated with the pivotal direction of the steering gear 360 (with the figures showing them connected to pivot together, although alternatively they could be connected to pivot in a particular ratio or other relationship to one another). So, holding the steering gear 360 in a particular pivotal direction also holds the steering wheel 230 in a correlated pivotal direction. And, torque generated by the steering motor 280 can be used to hold the steering wheel 230 in a non-centered direction, although a steering motor 280 used for that purpose should not only be capable of generating torque while it is holding a position (such as a servo or stepper motor) but also be able to do so while energized at a low enough level to avoid an unacceptable drain on the cart battery 490. Alternatively, as mentioned before, where a plunger hole 380 is available at a location angularly offset from the centering location 390 (as shown in FIGS. 1, 3, and 5-8), the steering wheel 230 can be held in a non-centered direction by using the solenoid 310 rather than the steering motor 280.

Preferably (as discussed further elsewhere herein), the solenoid 310 is energized substantially at the same time as the steering motor 280 and, while energized, retracts (which, as used herein, includes “holds”) the plunger 330 (assuming the solenoid 310 is setup to retract rather than release the plunger 330 while the solenoid 310 is energized). With the plunger 330 retracted, the steering gear 360 is freed to be pivoted by the steering motor 280 (via the steering motor gearbox 290). When the solenoid 310 is de-energized (again, along with the steering motor 280), it releases the plunger 330, allowing the plunger 330 (preferably with assistance of a biasing device like a spring, not shown) to impact and, if not already aligned with a plunger hole 380, slide along the surface of the steering gear 360. The steering gear 360 being urged by the tension spring 350 to pivot back toward the pivotal direction of the steering gear 360 that correlates with the centered direction of the steering wheel 230 (such correlated pivotal direction being the neutral direction of the steering gear 360). The tension spring 350 urges the steering gear 360 back as a result of being attached to the rear of the steering wheel support 250, which as already noted is coupled with the steering gear 360. (References herein to components being either coupled to or coupled with one another, or to them being connected by a coupling are, except where the context indicates otherwise, not limited to circumstances where one component only influences another component (e.g., without physical contact) but are also intended to be inclusive of circumstances where the components are fixedly or otherwise connected (directly or indirectly) with one another.) The plunger 330 can thus enter the first plunger hole 380 that comes into alignment (if not already aligned) with the plunger 330.

As can be seen in FIGS. 1, 3, 5, and 8-10, the tension spring 350 is attached at one end to the tension support 340 and at the other end to the rear of the steering wheel support 250. In FIGS. 1, 3, 5, and 7-10, the tension support 340 is shown attached to the steering wheel pivot support 240 (or alternatively, it could be attached to the connector block 210, which connects the rear leg 160 to the steerable wheel assembly 200). In the embodiments shown herein, the positions of the connector block 210, steering wheel pivot support 240, and tension support 340 all remain fixed relative to the positions of the steering motor 280 and the solenoid 310, and do not pivot with the steering wheel support 250. And, as shown in FIGS. 1, 3, 5, 6, 10 and 11, the top of the steering wheel support 250 is fixedly attached to the bottom of the steering gear 360—although, alternatively, these two components could be fixedly attached to each other indirectly such as by each being fixedly attached to the steering wheel pivot shaft 260 (again, not visible in FIG. 5) or they could be coupled to one another any other way that causes the steering wheel support 250 to pivot in response to pivotal movement of the steering gear 360. And, the steering wheel support 250 is shown rotatably connected to the steering wheel 230 via the steering wheel axle 255. Thus, pivotal movement of the steering gear 360 pivots the steering wheel support 250, which pivots the steering wheel 230—all such pivoting, in the embodiments shown herein, being about the centerline of the of the steering wheel pivot shaft 260 (although, alternative embodiments could have one or more of these components pivot about one or more different axes).

FIG. 6 shows a similar view as that shown in FIG. 5, except with the connector block 210 replaced by an alternative connector block 211 and with the tension support 340 replaced by an alternative tension support 341. As shown, the alternative connector block 211 has a more complex configuration than the connector block 210 shown in FIGS. 1, 3, 5 and 7-11. The connector block 210 has a configuration that is very simple (which is believed inexpensive to make) and could be easily adapted for rotation relative to the rear leg 160 (such as by removing one of its two screws 220, each of which preferably pass through one side of the connector block 210, through the rear leg 160, and thread into the connector block 210 on the opposite side of the rear leg 160). Thus, the connector block 210 is believed preferable to the alternative connector block 211. However, another embodiment may utilize the alternative connector block 211 where so desired. For example, it may be seen as providing some desirable (although likely more expensive) options for making the connection with the rear leg 160. The alternative connector block 211 can be aligned with the rather complex angle of the supported rear leg 160. The alternative connector block 211 has receiving channel sidewalls 212 that may be made sufficiently flexible for the single screw 220 to be tightened enough to secure the rear leg 160 by compressing the sidewalls 212 against it. The alternative connector block 211 could then be made pivotable relative to the rear leg 160 by simply loosening the single screw 220. And, the alternative connector block 211 can be disconnected from the pivot support 240 by unscrewing the bolt 150 located in an inset groove 213 cut into the alternative connector block 211. As also shown in FIG. 6, the alternative connector block 211 provides a top surface 214 properly sloped for attachment of an alternative tension support 341 that, at its distal (rearward) end, is positioned correctly for the attached tension spring 150 to pull (and thereby pivot) the steering wheel support 250 toward placing the steering wheel 230 in the centered direction. (The steering wheel 230 is shown oriented in the centered direction in FIG. 6, as it is in FIGS. 1, 3, 5, 7, 10 and 11.)

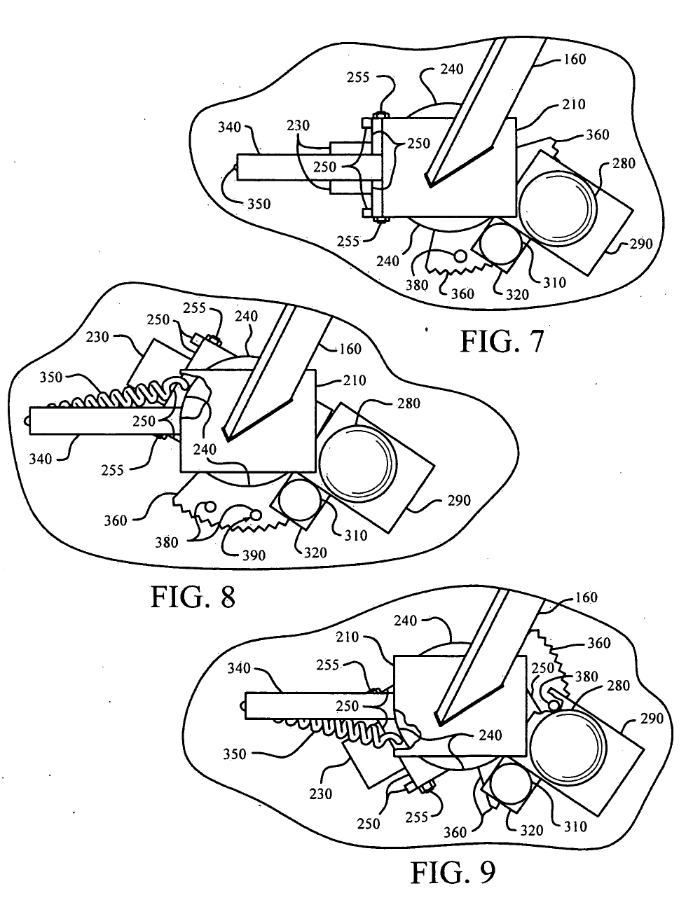

FIG. 7 shows a top view of the steerable wheel assembly 200 with the steering wheel 230 in the centered direction and with the steering gear 360 and its attached steering wheel support 250 oriented in their neutral directions, which, in these embodiments, coincide with the centered direction. Only a small portion of the tension spring 350, which connects the steering wheel support 250 to the tension support 340, is visible in FIG. 7. Both the steering wheel support 250 and steering wheel 230 are shown in FIG. 7, as they are in FIGS. 1, 3, 5, 6 and 8-10, pivotally oriented in the same direction since, in this embodiment, the steering wheel support 250 is aligned with and rotatably attached (at both sides of the steering wheel axle 255) to the steering wheel 230. In FIGS. 1, 3, 5-7 and 9-11, the pivotally oriented direction of the steering wheel support 250 is its neutral direction, and therefore the steering wheel 230 is in the centered direction. In the embodiment shown in FIGS. 1, 3, and 5-11, the steering wheel support 250 is fixedly attached to the steering gear 360. Thus, the steering gear 360, as shown in FIG. 7, as well as in FIGS. 1, 3, 5, 6, 10 and 11, although not aligned with the steering wheel 230, is oriented in its (the steering gear's) neutral direction—for the steering wheel 230, which is connected to the steering gear 360 via the steering wheel support 250, to be in the centered direction.

In FIG. 7, as well as in FIGS. 1, 3, 5, 6 and 8-11, the steering motor 280, the steering motor gearbox 290, and the solenoid 310 are shown in positions that are angularly offset from the centered direction of the rear wheel 230. And, their positions are shown, by comparison of FIG. 7 with FIGS. 8 and 9, to remain fixed while the steering gear 360, the steering wheel support 250, and the steering wheel 230 pivot together about the centerline of the pivot shaft 260 (visible only in FIGS. 10 and 11). It should be noted that, in the embodiments shown herein, the steering motor support plate 270 (not visible in FIG. 7, but shown in FIGS. 1, 3, 5, 6, 10 and 11) to which the steering motor gearbox 290 is attached, is fixedly attached to the steering wheel pivot support 240. And, the solenoid support plate 320, to which the housing of the solenoid 310 is attached, is fixedly attached to the steering motor support plate 270. The plunger hole 380 visible in FIG. 7, is one that is angularly offset in the clockwise direction from the centering location 390 (not visible in FIG. 7, but shown in FIGS. 8 and 10-11). With the steering wheel 230 in the centered direction, as it is shown in FIG. 7, the plunger 330 is extendable into the plunger hole 380 at the centering location 390 (although that plunger hole 380 and the centering location 390 are hidden by the solenoid 310 in FIG. 7); and, if so extended, the plunger 330 will hold the steering gear 360 in its neutral direction until the plunger 330 is retracted by the solenoid 310.

Having the positions of the steering motor 280, the steering motor gearbox 290, and the solenoid 310 offset from the centered direction is believed to help minimize the space occupied by those components. Those positions shown in FIGS. 7-9, as well as FIGS. 1, 3, 5, 6, 10 and 11, are selected based upon the sizes of the components used and on the need for positioning the gearbox output gear 370 and of the plunger 330 properly for them to operate on the steering gear 360. However, in alternative embodiments, all or some of these components of the steerable wheel assembly 200 may be replaced by components of a different size or shape or may be re-located, so that the positions relative to one another may be adjusted as needed or desired, and remain within the scope of the invention.

FIGS. 8 and 9 show the same steerable wheel assembly 200 shown in FIG. 7 but in FIGS. 8 and 9, the steering wheel 230 is in a non-centered direction. FIG. 8 shows the steering wheel 230 pivoted clockwise from the centered direction, for the cart 10 to turn left when it moves forward. FIG. 9 shows the steering wheel 230 pivoted counter-clockwise from the centered direction, for the cart 10 to turn right when it moves forward. As shown in FIG. 8, the centering location 390 comes into view when the steering gear 360 is pivoted sufficiently in the clockwise direction, which occurs as a result of the steering motor 280 being energized to rotate (meaning to rotate its shaft, which is not shown but which engages with one or more gears (not shown) within the steering gearbox 290) in the correct angular direction for the steering gearbox output gear 370 (not visible in FIG. 8 or 9, but shown in FIGS. 10 and 11) to rotate in a counter-clockwise direction.

The steering gear 360 (and thus the steering wheel 230) may be held in the pivotal direction shown in FIG. 8, either by the steering motor 280 holding the steering gearbox output gear 370 at a correlated rotational position or by the solenoid 310 allowing (or forcing, depending on the way the solenoid 310 is set up) the plunger 330 (not visible in FIG. 8 or 9, but shown in FIGS. 10 and 11) to extend into a plunger hole 380 that is aligned with the plunger 330. In the embodiment shown in FIGS. 7-9, the plunger hole 380 that is aligned with the plunger 330 (which is a different plunger hole 380 in each of those figures) is covered by the solenoid 310. The plunger holes 380 that are not visible in FIG. 9 are visible in FIG. 8. The plunger hole 380 that is covered in FIG. 8 is positioned at a location on the steering gear 360 that is angularly offset from the centering location 390 in the counter-clockwise direction by the same amount as the plunger hole 380 is shown offset from the centering location 390 in the clockwise direction—both non-centering plunger holes being mirror images of one another relative to the radial of the steering gear 360 that passes through the center of the centering location 390. (This is not to suggest that the invention is limited to any particular number of plunger holes, to any plunger holes being offset from the centering location, or to any such offset being in the same amount as or being on the opposite side from another plunger hole. For example, an alternative embodiment may have any number of plunger holes, which may be angularly separated from one another by varying amounts and/or may be positioned more on one side of the centering location than on the other side.)

The plunger hole 380 that is covered by the solenoid 310 in FIG. 8 is seen in FIG. 9 through a cutout section of the steering motor gearbox 290. With the steering gear 360 in the pivotal direction shown in FIG. 9, the solenoid 310 is directly above the plunger hole 380 that is shown in FIG. 8 as angularly offset in the clockwise direction from the centering location 390. And, therefore, the steering gear 360 (and thus the steering wheel 230) can be held in the pivotal direction shown for it in FIG. 9 in the same manner as discussed above with regard to holding the steering gear 360 in the pivotal direction shown for it in FIG. 8. As shown in FIGS. 7-9, the positions of the steering motor 280 and the solenoid 310 are fixed relative to the positions of the pivot support 240 and connector block 210, and do not pivot with the steering gear 360, steering wheel support 250, or steering wheel 230.

As further shown in FIGS. 8 and 9, the tension spring 350 is attached at one end to the rear end of the tension support 340 and at the other end to the rear of the steering wheel support 250 (the latter attachment being visible through a cutout section of the connector block 210). FIGS. 8 and 9 show the tension spring 350 being stretched and angularly displaced (to the left in FIG. 8 and to the right in FIG. 9) by pivotal movement of the steering wheel support 250. The stretching causes an increase in the spring's tension and the angular displacement causes the tension to produce a component of force at the point where the tension spring 350 connects to the steering wheel support 250 that opposes the displacement. Thus, the tension spring 350 urges the steering wheel support 250, and thus the steering wheel 230 and the steering gear 360, to rotate back toward the centering direction for the steering wheel 230.

FIG. 10 shows a right side view of the steerable wheel assembly 200 with the steering wheel in the centered direction. The steering gear 360, steering wheel support 250, and steering wheel 230, and the steering wheel pivot shaft 260 (referred to collectively herein as the pivot components) are all pivotable together about the centerline of the steering wheel pivot shaft 260. Whereas, the steering motor 280, the steering motor gearbox 290, the solenoid 310, the steering motor support plate 270, the solenoid support plate 320, the steering wheel pivot support 240, tension support 340, and the connector block 210 are all fixed in their respective positions relative to one another and do not pivot with the pivot components. (The pivot shaft 260, preferably, is cylindrical in shape, although it could be any shape that provides a pivotable connection between the pivot support 240 and the steering wheel support 250. And, in other embodiments, the pivot shaft 260 may be fixed to the pivot support 240 and pivotable relative to the steering wheel support 250, or the pivot shaft 260 may be pivotable relative to both the pivot support 240 and the steering wheel support 250, without deviating from the invention.)

As indicated in the above discussions relating to FIGS. 7-9, the tension spring 350 in the embodiments shown herein is pivotable about each of its attachment points, one on the tension support 340 and the other on the steering wheel support 250. Therefore, the tension spring 350 pivots (although in an opposite angular direction) in response to pivotal movement of the steering wheel support 250. (However, in alternative embodiments, the tension spring 350, or another form of self-centering device, may be fixed at one or both ends.) The tension in the tension spring 350 has no component acting to pivot the steering wheel support 250 while it is in its neutral direction. But, as indicated above, such a component develops and increases as the tension spring 350 is pivoted and stretched by pivotal movement of the steering wheel support 250 away from its neutral direction. (As used herein, pivotal movement—sometimes referred to herein as pivotal motion—of a component is angular movement of the component within a plane that is perpendicular to the pivot axis for the component. Such a plane is referred to herein as a pivot plane. The pivot axis for all the pivot components in the embodiments shown herein, is the centerline of the pivot shaft 260.)

FIG. 11 shows a portion of the view shown in FIG. 10 at a magnified scale, centering on the solenoid 310 with its plunger 330 extended into the pivot hole 280 (not visible in this side view) at the centering location 390, the steering gear 360, the steering gearbox output gear 370, and the steering gearbox shaft 300. The steering gearbox shaft 300 extends from the output end of the steering motor gearbox 290, and transmits rotational speed and torque generated by the steering motor 280 (as modified by the steering motor gearbox 290) to the steering gearbox output gear 370, which is fixedly attached to the steering gearbox shaft 300. The steering gearbox output gear 370 is engaged with the steering gear 360 and by such engagement is able to pivot the steering gear 370 in response to rotation of the steering gearbox shaft 300 (which, as already noted, rotates in response to rotation generated by the steering motor 280 while it is energized). Also, by such engagement, the output gear 370 is able to transmit holding torque to the steering gear 360—and thus to hold the steering gear 360 in a pivotal direction such as a direction other than its neutral direction—if, for example, the steering motor 280 is one that can hold an angular position against opposing torque (e.g., if the steering motor can continue generating torque while static or otherwise stop and maintain itself in an angular position). If the steering motor 280 is being used to hold the steering gear 360 in place, release of that hold, e.g., by response of the steering motor 280 to de-activation of the right- or left-turn button 560,561 (or upon another activation of one of those buttons, activation of a separate operator input device (not shown), or operation of a timing or other automatic device (not shown) for causing the steering motor 280 to be de-energized or to otherwise release the hold), allows the urging of the tension spring 350 to pivot the steering wheel support 250 (thus the steering gear 360) back toward its neutral direction.

As also shown in FIG. 11, the solenoid 310 can hold the steering gear 360 in place, instead of relying on the steering motor 280 to do so. The solenoid 310 is shown in FIG. 11 with the solenoid plunger 330 extended downwardly through the steering gear 360 (by passing through a solenoid hole 380 not visible in this side view) at the centering location 390, and thus holding the steering gear 360 in its neutral direction. As discussed above, activation of a right- or left-turn button 560,561 on the remote control 20 (or, if provided, on the handle 140) causes the solenoid 310 to retract the plunger 330 above the steering gear, and causes the steering motor 280, at substantially the same time, to be energized and generate torque and rotate in the appropriate angular direction (considering the gearing arrangement in the steering motor gearbox 290) for pivoting the steering gear 360 (and thus the steering wheel support 250 and the steering wheel 230) counter-clockwise (for the cart 10 to turn right) or clockwise (for the cart 10 to turn left). If the steering gear 360 has one or more plunger holes 380 that are angularly offset to the right and/or left of the centering location 390 (such as those shown in FIGS. 7-9), the solenoid 310 can be used to hold the steering gear 360 by allowing (or forcing) the plunger 330 to extend downwardly into such offset plunger hole 380, similarly to what is shown in FIGS. 10 and 11 with respect to the plunger hole 380 (not visible in those side views) that is positioned at the centering location 390. Upon retraction of the plunger 330, e.g., by response of the solenoid 310 to a momentary (or longer) activation of the right- or left-turn button 560,561 (or upon activation of a separate operator input device (not shown) for causing the solenoid 310 to retract the plunger 330), the urging of the tension spring 350 is allowed to pivot the steering wheel support 250 (thus the steering gear 360) back toward its neutral direction.

An example of generalized electrical relationships between several of the electrical components that are controllable by the remote control 20 is shown in FIG. 12 in the form of a block diagram for a basic embodiment of the cart shown in FIG. 1 and in the other figures provided herein. Preferably, the remote control 20 is able to respond to activation of any of its onboard operator input devices (which as shown in FIG. 12 include two steering input devices—the right-turn button 560 and the left-turn button 561—and three drive input devices—the go-stop button 460, the go-faster button 461, and the go-slower button 462) by generating and transmitting, over the remote control transmitting antenna 570, a wireless command signal with a signature (e.g., an electromagnetic signature) that the receiver 520 is able to receive through the receiver antenna 550 and is tuned to identify for communication of an electrical control signal to an appropriate relay (not shown in FIG. 12) in the relay-switch box 530. Upon receipt of the control signal, the appropriate relay switches “on” the power circuit that then receives electrical energy from the cart battery 490 and provides it to the component or components that are electrically connected to that circuit (e.g., where the circuit serves as the component's power circuit). If the command signal is for steering right or left (e.g., generated in response to activation of the right- or left-turn button 560,561), the appropriate relay is one (or more than one) that closes the power circuit(s) to which the steering motor 280 and the steering solenoid 310 are electrically connected (via, of course, the appropriate terminals for the motor to rotate in the proper direction and for the solenoid to retract the plunger to carry out the command). In FIG. 12, the steering motor 280 and steering solenoid 310 are shown sharing a common connection for receiving electric power (also referred to as a power signal) from the cart battery 490. As a result, the steering motor 280 and steering solenoid 310 shown in FIG. 12 are energized (and de-energized) substantially simultaneously. (The relay for the steering motor's power circuit is not shown in FIG. 12, but see discussion below regarding FIG. 13 in which the same relay (in location and function) is shown and designated as steering relay 601. The steering motor's power circuit is shown in FIGS. 12 and 13 symbolically as represented by lines connecting the steering motor 280 and steering solenoid 310 to the cart battery 490 via the relay-switch box 530, and, as shown in FIG. 13, via relays within the relay-switch box 530.) If the command signal is a drive command, such as a “go,” “go-faster,” or “go-slower” command, the receiver 520 sends an electrical control signal to the appropriate relay (not shown) in the relay-switch box 530 for providing electric power to the drive motor speed control box 540 for powering a motor speed control device (not shown) therein to then communicate a controlled (e.g., regulated) amount of electric power to the drive motor 430. It is appreciated that, although not shown in FIG. 12, the motor speed control device may be one that has self-contained relays and other electronics that make it possible to connect directly with the cart battery 490 and/or the receiver 520, thus making it unnecessary to receive its electric power and/or control signals via the separate relay-switch box 530. As shown in FIGS. 12 and 13, the remote control 20 and the receiver 550 are powered by their own separate power supplies, such as their own onboard batteries (not shown). However, the receiver 520 could, and in many applications preferably would, be electrically connected to the cart battery 490 for utilizing it as the power supply for the receiver 520.

FIG. 13 shows a variation on the setup shown in FIG. 12, from a viewpoint focused more closely on the steering motor 280 and steering solenoid 310. Although it is believed the simultaneous energizing of the steering motor 280 and the steering solenoid 310 works well, there may be circumstances where a brief time delay is needed to avoid the steering motor 280 moving the steering gear 360 (not shown in FIG. 13) before the plunger 330 (not shown in FIG. 13) is retracted from a plunger hole 380 (not shown in FIG. 13), since such movement of the steering gear 360 could cause the plunger 330 to jam (or wear excessively). Therefore, as shown in FIG. 13, the steering motor 280 and the steering solenoid 310 can be connected to the same power circuit, as they are in FIG. 12, but with a time-delay relay (such as a normally-open, timed-closed NOTC relay, identified in FIG. 13 as NOTC 602) inserted between the steering motor 280 and the common connection point. As a result of the time-delay relay, there is a slight delay in the time the steering motor 280 is energized relative to the time the steering solenoid 310 is energized. If this setup is used, preferably a time-delay relay is selected that allows just enough time for the steering solenoid 310 to retract the plunger 330 out of the plunger hole 380 before the plunger receptor (which is consolidated into the steering gear 360 in the embodiments shown) begins to pivot in response to rotational movement generated by the steering motor 280. (Note that the setup in FIG. 12, with regard to the operation of the steering motor 280 and the steering solenoid 310, can be in most respects the same as the setup shown in FIG. 13. For example, each of these setups have a common connection between the steering motor 280 and the steering solenoid 310 to the same power circuit for receiving electric power from the cart battery 490 and each of them can have the power circuit opened and closed by a single steering relay 601 (shown in FIG. 13 but not in FIG. 12) located in the relay-switch box 530. But, the setup in FIG. 12 does not have the time-delay relay NOTC 602 that is shown in FIG. 13 between the steering motor 280 and the common connection point.)

It should be understood that the present invention contemplates and includes all conventional adjustments and modifications to the embodiments described or shown herein, including alternate embodiments of the present invention that have conventional differences in size, shape, proportion, orientation, or direction of movement from those described or shown herein, without departing from the present invention.

Accordingly, the invention claimed is not limited to the embodiments described or shown herein, but encompasses any and all embodiments within the scope of the claims and is limited only by such claims.

What is claimed is:

1. A cart comprising a front-located drive wheel assembly with a drive motor for moving the cart forward by rotating at least one drive wheel; and, a rear-located steerable wheel assembly for turning the cart, the steerable wheel assembly comprising a steering motor, a center-lock device, and a cart steering wheel, the steering wheel being pivotable through pivotal directions that include a centered direction, wherein the steering motor generates torque in response to the steering motor being electrically energized and is rotatable in response to said torque, the steering motor being coupled to the steering wheel for pivoting the steering wheel in response to rotation of the steering motor, wherein the center-lock device is adapted for moving a locking means between positions comprising a lock position and an unlock position in response to the center-lock device being electrically energized, wherein the locking means holds the steering wheel in the centered position while the locking means is in the lock position and releases said hold when the locking means is moved to the unlock position, and wherein the steering motor and center-lock device are energized in response to transmission of one or more command signals generated in response to activation of at least one operator input device.

2. A cart, wherein the cart comprises:
a. a frame having a front end and a rear end, wherein the frame is capable of carrying a cart electric power source;
b. a drive wheel assembly located at or near the front end, the drive wheel assembly comprising a drive wheel and a drive motor, wherein the drive wheel has a drive wheel axis about which the drive wheel is rotatable and wherein the drive motor is operably connected to the drive wheel for applying drive torque to the drive wheel while the drive motor is electrically energized, for rotating the drive wheel about the drive wheel axis in response to said drive torque and for said rotation of the drive wheel to move the cart forward;
c. a steerable wheel assembly located rearward of the drive wheel axis, the steerable wheel assembly comprising
(i) a pivot support connector for connecting the steerable wheel assembly to the cart frame;
(ii) a cart steering wheel having a steering wheel axis about which the steering wheel is rotatable;
(iii) a steering wheel support for connecting the steering wheel to the pivot support connector, the steering wheel support being pivotally connected to the pivot support connector for allowing the steering wheel support to pivot about a pivot axis wherein said pivotal movement of the steering wheel support pivots the steering wheel by changing the orientation of the steering wheel axis;
(iv) a steering motor that is capable of developing torque while it is electrically energized, the steering motor being electrically connectable to the cart electric power source or another electric power source carried by the frame, for electrically energizing the steering motor in response to transmission of a command signal generated in response to activation of an operator input device for steering the cart, the steering motor being coupled to the steering wheel support wherein at least some of the torque generated by the steering motor is transmitted to the steering wheel support for pivoting the steering wheel support about the pivot axis; (iv) an electrically activatable center-lock device, wherein the center-lock device includes a plunger, the plunger being movable between positions that comprise an extended position and a retracted position in response to the center-lock device being electrically energized or de-energized, wherein the center-lock device is electrically coupled with the steering motor for the center-lock device to be electrically energized or de-energized in coordination with the steering motor being electrically energizing or de-energized; and,
(v) a plunger receptor comprising a plunger hole, the plunger hole having dimensions for receiving at least part of the plunger, wherein the plunger receptor is connected to the steering wheel support for the plunger receptor to pivot in response to pivotal movement of the steering wheel support and for the plunger receptor to hold the steering wheel support in a steering wheel support neutral direction while the plunger receptor is held in a plunger receptor neutral direction, wherein the plunger hole is at a centering location on the plunger receptor, the centering location being selected for the plunger hole to align with the plunger when the steering wheel is in a centered direction, and wherein the center-lock device is located for aligning the plunger with the centering location when the plunger receptor is in the plunger receptor neutral direction and, when so aligned, for at least part of the plunger to be moveable into the plunger hole for holding the plunger receptor in the plunger receptor neutral direction, and for the plunger to be moveable out of the plunger hole for allowing the plunger receptor to pivot to another pivotal direction.

3. The cart of claim 2 wherein the steerable wheel assembly further comprises a self-centering device, for biasing the steering wheel toward the centered direction in response to pivotal displacement of the steering wheel from the centered direction.

4. The cart of claim 2 wherein the coupling between the steering motor and the steering wheel support includes a pivotable steering gear, wherein at least some of the torque transmitted to the steering wheel is transmitted via the steering gear, the steering gear being connected to the steering wheel support for the steering wheel support to pivot about the pivot axis in response to movement of the steering gear.

5. The cart of claim 4 wherein the steering gear comprises the plunger receptor.

6. The cart of claim 3 wherein the coupling between the steering motor and the steering wheel support includes a steering gear, wherein at least some of the torque transmitted to the steering wheel is transmitted via the steering gear, the steering gear being connected to the steering wheel support for the steering wheel support to pivot about the pivot axis in response to movement of the steering gear.

7. The cart of claim 4 wherein the steerable wheel assembly further comprises a self-centering device, for biasing the steering wheel toward the centered direction in response to pivotal displacement of the steering wheel from the centered direction.

8. The cart of claim 5 wherein the steerable wheel assembly further comprises a self-centering device, for biasing the steering wheel toward the centered direction in response to pivotal displacement of the steering wheel from the centered direction.

9. The cart of claim 6 wherein the steering gear comprises the plunger receptor.

10. The cart of claim 7 wherein the steering gear comprises the plunger receptor.

11. The cart of claim 2 wherein the drive motor is located proximate the drive wheel axis and wherein the center of gravity of the electric power source is located forward of the drive wheel axis.

12. The cart of claim 11 wherein the steerable wheel assembly further comprises a self-centering device, for biasing the steering wheel toward the centered direction in response to pivotal displacement of the steering wheel from the centered direction.

13. The cart of claim 11 wherein the coupling between the steering motor and the steering wheel support includes a pivotable steering gear, wherein at least some of the torque transmitted to the steering wheel is transmitted via the steering gear, the steering gear being connected to the steering wheel support for the steering wheel support to pivot about the pivot axis in response to movement of the steering gear.

14. The cart of claim 12 wherein the coupling between the steering motor and the steering wheel support includes a pivotable steering gear, wherein at least some of the torque transmitted to the steering wheel is transmitted via the steering gear, the steering gear being connected to the steering wheel support for the steering wheel support to pivot about the pivot axis in response to movement of the steering gear.

15. The cart of claim 13 wherein the steering gear comprises the plunger receptor.

16. The cart of claim 14 wherein the steering gear comprises the plunger receptor.

17. A method for steering a cart, the method comprising the steps of:
a. generating a command signal for pivoting a steering wheel on a cart;
b. retracting a plunger from a plunger hole in a plunger receptor in response to the command signal;
c. generating rotational movement of a steering motor in response to the same or another command signal and transmitting at least some of the rotational movement to the plunger receptor;
d. pivoting the plunger receptor away from a neutral direction;
e. pivoting the steering wheel away from a centered direction in response to said pivoting of the plunger receptor away from the neutral direction;
f. allowing or forcing the plunger to extend toward the plunger receptor;
g. ceasing the generation of the rotational movement;
h. pivoting the plunger receptor, or allowing the plunger receptor to pivot, toward the neutral direction;
i. pivoting the steering wheel, or allowing the steering wheel to pivot, toward the centered direction;
j. allowing or forcing the plunger to enter the same or a different plunger hole, the plunger thereby holding the steering wheel against pivoting.

18. The method of claim 17 further comprising the step of generating a second command signal for stopping the pivoting of the steering wheel.

19. The method of claim 17 further comprising the step of using the steering motor for holding the steering wheel against pivoting.

20. The method of claim 18 further comprising the step of using the steering motor for holding the steering wheel against pivoting.
